(19) United States
(12) Patent Application Publication
(10) Pub. No.: US 2020/0264303 A1
(43) Pub. Date: Aug. 20, 2020

(54) SYSTEMS, METHODS, AND MEDIA FOR DETERMINING A THREE DIMENSIONAL LOCATION OF AN OBJECT ASSOCIATED WITH A PERSON AT RISK OF FALLING DOWN

(71) Applicant: Mayo Foundation for Medical Education and Research, Rochester, MN (US)

(72) Inventors: Daniel J. Schwab, Mantorville, MN (US); Christopher L. Felton, Rochester, MN (US); Bruce R. Kline, Winona, MN (US); Barry K. Gilbert, Rochester, MN (US); Gary S. Delp, Rochester, MN (US); Clifton R. Haider, Rochester, MN (US)

(21) Appl. No.: 16/793,762

(22) Filed: Feb. 18, 2020

Related U.S. Application Data
(60) Provisional application No. 62/807,321, filed on Feb. 19, 2019.

(51) Int. Cl. G01S 15/88; G01S 15/10; G01S 15/46; G01S 7/527; G01S 7/524; H01Q 1/27; H01Q 1/00

(52) U.S. Cl. CPC G01S 15/88; G01S 15/101; G01S 15/46; H01Q 1/007; G01S 7/524; H01Q 1/273; G01S 7/5273

(57) ABSTRACT

In accordance with some embodiments of the disclosed subject matter, mechanisms (which can, for example, include systems, apparatuses, methods, and media) for determining three dimensional location of an object associated with a person at risk of falling down are provided. In some embodiments, the apparatus comprises: an ultrasound detector; an antenna; and a processor, the processor programmed to: detect a first ultrasound signal at a first time using the ultrasound detector; in response to detecting the first ultrasound signal, cause a first wireless signal to be emitted by the antenna; detect a second ultrasound signal at a second time; in response to detecting the second ultrasound signal, cause a second wireless signal to be emitted by the antenna; determine that a first amount of time has passed since the second ultrasound signal was detected; and in response to determining that the first amount of time has passed since the second ultrasound signal was detected, cause the wearable apparatus to enter a low power state.

### CROSS-REFERENCE TO RELATED APPLICATIONS

This application is based on, claims the benefit of, and claims priority to U.S. Provisional Application No. 62/807,321, filed Feb. 19, 2019, which is hereby incorporated herein by reference in its entirety for all purposes.

### STATEMENT REGARDING FEDERALLY SPONSORED RESEARCH

N/A

### BACKGROUND

The elderly are often at risk of falling, which can result in various serious injuries such as broken hips, broken ribs, and head trauma. When such a fall occurs, it is imperative that the fallen victim receive adequate care in a timely manner. However, it is cost prohibitive and often undesirable to personally monitor persons that are at risk of falling. For example, while many elderly persons are at risk of incurring injuries from falls, those persons are often capable of living independently and would object to having a person constantly monitoring them for falls. While such a person can be provided with a device that is kept on their person that allows them to request help in the case of a fall, an injury suffered due to the fall may render the person unconscious or disoriented and unable to utilize the device.

While automated approaches may be more cost effective and more acceptable to persons at risk of falling than monitoring by a human observer, practical and reliable automated systems that are capable of reliably determining that a person has fallen down are not commercially available.

Accordingly, new systems, methods, and media for determining three dimensional location of an object associated with a person at risk of falling down are desirable.

### SUMMARY

In accordance with some embodiments of the disclosed subject matter, systems, methods, and media for determining three dimensional location of an object associated with a person at risk of falling down are provided.

In accordance with some embodiments of the disclosed subject matter, a system for determining three dimensional location of a remote monitor associated with a person at risk of falling down is provided, the system comprising: a first ultrasonic transducer at a first position in relation to a monitored space; a second ultrasonic transducer at a second position in relation to the monitored space; a detector; and a processor coupled to the first ultrasonic transducer, the second ultrasonic transducer, and the detector, the processor programmed to: cause the first ultrasonic transducer to emit a first ultrasound signal at a first time; detect, at a second time that is subsequent to the first time using the detector, a first wireless signal emitted by the remote monitor; determine a first distance value, representing a distance between the first ultrasonic transducer and the remote monitor at the second time based on a difference between the first time and the second time and a propagation speed of sound in the monitored space; cause the second ultrasonic transducer to emit a second ultrasound signal at a third time that is subsequent to the first time; detect, at a fourth time that is subsequent to the third time using the detector, a second wireless signal emitted by the remote monitor; and determine a second distance value, representing a distance between the second ultrasonic transducer and the remote monitor at the fourth time based on a difference between the third time and the fourth time and the propagation speed of sound in the monitored space.

In some embodiments, the processor is further programmed to determine a location of the remote monitor within the monitored space based on the first distance value, the first position, the second distance value, and the second position.

In some embodiments, the system further comprises a third ultrasonic transducer at a third position in relation to the monitored space, and the processor programmed to: cause the third ultrasonic transducer to emit a third ultrasound signal at a fifth time; detect, at a sixth time that is subsequent to the fifth time using the detector, a third wireless signal emitted by the remote monitor; and determine a third distance value, representing a distance between the third ultrasonic transducer and the remote monitor at the sixth time based on a difference between the fifth time and the sixth time and the propagation speed of sound in the monitored space.

In some embodiments, the processor is further programmed to determine a location of the remote monitor within the monitored space based on the first distance value, the first position, the second distance value, the second position, the third distance value, and the third position.

In some embodiments, the first wireless signal is a radio frequency signal.

In some embodiments, a frequency of the first wireless signal is in the range of about 900 MHz to about 930 MHz.

In some embodiments, a frequency of the first wireless signal is in the 900 MHz ISM band.

In some embodiments, the first wireless signal is a non-modulated signal.

In some embodiments, the first wireless signal is a non-modulated signal, and a frequency of the first wireless is useable to identify the remote monitor from a plurality of remote monitors each configured to emit wireless signals at different frequencies.

In some embodiments, the detector comprises a photodetector, and the first wireless signal is an optical signal

In some embodiments, the first wireless signal is encoded with identifying information associated with the remote monitor.

In some embodiments, the first wireless signal is encoded with identifying information associated with the person.

In some embodiments, the first wireless signal is encoded with a value indicative of a temperature measured by the remote monitor.

In some embodiments, the third time is subsequent to the first time by no more than 0.5 seconds.

In some embodiments, the processor is further programmed to transmit the first distance value and the second distance value to a central monitoring system that is programmed to determine a location of the remote monitor within the monitored space based on the first distance value and the second distance value.

In some embodiments, the processor is further programmed to transmit an instruction to the first ultrasound transducer to emit the first ultrasound signal at the first time over a power line network to which both the processor and the first ultrasound transducer are coupled.

In some embodiments, the processor is further programmed to transmit an instruction to the first ultrasound transducer to emit the first ultrasound signal at the first time over a low voltage line corresponding to the first ultrasound transducer.

In some embodiments, the processor is further programmed to transmit an instruction to the first ultrasound transducer to emit the first ultrasound signal at the first time over a low voltage network to which both the processor and the first ultrasound transducer are coupled.

In some embodiments, the processor is further programmed to transmit an instruction to the first ultrasound transducer to emit the first ultrasound signal at the first time by causing a an activation signal to be emitted by a wireless transmitted coupled to the processor.

In some embodiments, the processor is further programmed to: determine that at least a first amount of time has elapsed since emission of a most recent ultrasound signal; in response to determining that at least the first amount of time has elapsed, cause the first ultrasonic transducer to emit the first ultrasound signal at a seventh time; detect, at an eighth time that is subsequent to the seventh time using the detector, a fourth wireless signal emitted by the remote monitor; and determine a fourth distance value, representing a distance between the first ultrasonic transducer and the remote monitor at the eighth time based on a difference between the seventh time and the eighth time and the propagation speed of sound in the monitored space.

In some embodiments, the first amount of time is at least 10 seconds.

In some embodiments, the processor is further programmed to: detect, at a ninth time that is subsequent to the first time using the detector, a fifth wireless signal emitted by a second remote monitor; determine a fifth distance value, representing a distance between the first ultrasonic transducer and the second remote monitor at the ninth time based on a difference between the first time and the ninth time and the propagation speed of sound in the monitored space; detect, at a tenth time that is subsequent to the third time using the detector, a sixth wireless signal emitted by the second remote monitor; and determine a sixth distance value, representing a distance between the second ultrasonic transducer and the second remote monitor at the tenth time based on a difference between the third time and the tenth time and the propagation speed of sound in the monitored space.

In some embodiments, the processor is further programmed to: cause the first ultrasonic transducer to enter a receive mode subsequent to the first time; cause the second ultrasonic transducer to enter a receive mode subsequent to the first time and prior to the third time; detect, at an eleventh time using the second ultrasonic transducer, the first ultrasound signal; detect, at a twelfth time using the first ultrasonic transducer, an ultrasound signal emitted by the remote monitor in response to the remote monitor detecting the first ultrasound signal; detect, at a thirteenth time using the second ultrasonic transducer, the third ultrasound signal; redetermine the first distance value based on a difference between the eleventh time and the twelfth time and the propagation speed of sound in the monitored space; and redetermine the second distance value based on a difference between the thirteenth time and the twelfth time and the propagation speed of sound in the monitored space.

In some embodiments, a wearable apparatus is provided, comprising: an ultrasound detector; an antenna; and a processor, the processor programmed to: detect a first ultrasound signal at a first time using the ultrasound detector; in response to detecting the first ultrasound signal, cause a first wireless signal to be emitted by the antenna; detect a second ultrasound signal at a second time; in response to detecting the second ultrasound signal, cause a second wireless signal to be emitted by the antenna; determine that a first amount of time has passed since the second ultrasound signal was detected; and in response to determining that the first amount of time has passed since the second ultrasound signal was detected, cause the wearable apparatus to enter a low power state.

In some embodiments, the processor is further programmed to cause the wearable apparatus to enter a high power state in response to detection of the first ultrasound signal during a period of time during which the wearable apparatus is in the low power state.

In some embodiments, the wearable apparatus further comprises a second antenna, and the processor is further programmed to: detect a third ultrasound signal at a third time using the ultrasound detector, wherein the third time falls between the first time and the second time; and in response to detecting the third ultrasound signal, cause a third wireless signal to be emitted by the second antenna.

In some embodiments, the wearable apparatus further comprises a battery.

In some embodiments, the wearable apparatus further comprises a temperature sensor, and the processor is further programmed to encode a value indicative of an output of the temperature sensor in the first wireless signal.

In some embodiments, the value represents the temperature measured by the temperature sensor.

In some embodiments, the value represents a logical value indicative of whether the temperature measured by the temperature sensor falls within a range corresponding to body temperature.

In some embodiments, the processor is further programmed to: determine that at least a second amount of time has passed without detection of an ultrasound signal; and in response to determining that at least a second amount of time has passed without detection of an ultrasound signal, cause a fourth wireless signal to be emitted by the antenna.

In some embodiments, the processor is further programmed to encode the fourth wireless signal with information indicating that the fourth wireless signal does not correspond to a detection of an ultrasound signal.

In some embodiments, the processor is further programmed to encode the first wireless signal with identifying information associated with the wearable apparatus.

In some embodiments, the processor is further programmed to cause the first wireless signal to be emitted using a particular frequency that is associated with the wearable apparatus in lieu of encoding the first wireless signal with identifying information associated with the wearable apparatus.

In some embodiments, the processor is further programmed to: determine a duration of the first ultrasound signal; and cause a duration of the first wireless signal to be equal to the duration of the first ultrasound signal.

In some embodiments, the wearable apparatus further comprises a pressure sensor, wherein the processor is further programmed to encode a value indicative of an output of the pressure sensor in the first wireless signal.

In some embodiments, the wearable apparatus further comprises a proximity detector coupled to a proximity coil, wherein the processor is further programmed to encode a value indicative of a state of the proximity coil in the first wireless signal.

In some embodiments, the wearable apparatus further comprises a button, and the processor is further programmed to: determine that the button has been actuated; and in response to determining that the button has been actuated, cause a wireless signal that indicates that the button has been actuated to be emitted by the antenna.

In some embodiments, the wearable apparatus further comprises an ultrasonic transducer, wherein the processor is further programmed to: in response to detecting the first ultrasound signal, cause a third ultrasound signal to be emitted by the ultrasonic transducer after a predetermined period of time.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

The patent or application file contains at least one drawing executed in color. Copies of this patent or patent application publication with color drawing(s) will be provided by the Office upon request and payment of the necessary fee.

FIG. 1 shows an example of a system for determining three dimensional location of an object associated with a person at risk of falling down in accordance with some embodiments of the disclosed subject matter.

FIG. 2 shows an example of a block diagram of a system for determining three dimensional location of an object associated with a person at risk of falling down in accordance with some embodiments of the disclosed subject matter.

FIG. 3 shows an example of hardware that can be used to implement the remote monitor and the local monitor of FIG. 1 in accordance with some embodiments of the disclosed subject matter.

FIG. 4A shows an example of hardware components that can be used to implement a portion of the remote monitor of FIG. 1 in accordance with some embodiments of the disclosed subject matter.

FIG. 4B shows an example of the placement of components that can be used to implement the remote monitor of FIG. 1 in a particular form factor in accordance with some embodiments of the disclosed subject matter.

FIGS. 5A and 5B show an example of hardware components that can be used to implement the local monitor of FIG. 1 in accordance with some embodiments of the disclosed subject matter.

FIG. 6 shows an example of a system that can be used to determine the location of a remote monitor associated with a subject and to receive physiological data of the subject using a remote physiology monitor in accordance with some embodiments of the disclosed subject matter.

FIG. 7A shows a cross-sectional view of a room in which a system for determining three dimensional location of an object associated with a person at risk of falling down has been implemented in accordance with some embodiments of the disclosed subject matter.

FIG. 7B shows a top-down view of the room in which a system for determining three dimensional location of an object associated with a person at risk of falling down has been implemented in accordance with some embodiments of the disclosed subject matter.

FIG. 8 shows an example of a process for determining three dimensional location of an object associated with a person at risk of falling down in accordance with some embodiments of the disclosed subject matter.

FIG. 9 shows an example 900 of a process for receiving and relaying signals that can be used to determine a three dimensional location of an object in accordance with some embodiments of the disclosed subject matter.

FIG. 10 shows an example of a facility equipped with a system for determining three dimensional location of objects in and around the facility implemented in accordance with some embodiments of the disclosed subject matter.

FIG. 11 shows examples of remote monitors with different form factors that can be used in connection with a system for determining three dimensional location of objects in accordance with some embodiments of the disclosed subject matter.

FIG. 12 shows an example of a facility having multiple rooms each equipped with a portion of a system for determining three dimensional location of objects in and around the facility implemented in accordance with some embodiments of the disclosed subject matter.

FIG. 13 shows an example of a facility having multiple rooms with variable numbers of objects to be located with each room equipped with a portion of a system for determining three dimensional location of objects in and around the facility implemented in accordance with some embodiments of the disclosed subject matter.

FIG. 14A shows a cross-sectional view of a room in which multiple remote monitors are located equidistant from multiple ultrasound transducers.

FIG. 14B shows a top-down view of the room in which multiple remote monitors are located equidistant from multiple ultrasound transducers.

FIG. 15A shows a cross-sectional view of a room that includes an object that reflects an ultrasound signal creating the potential to cause errors in a location determination by a system for determining three dimensional location of an object associated with a person at risk of falling down has been implemented in accordance with some embodiments of the disclosed subject matter.

FIG. 15B shows a top-down view of the room that includes an object that reflects an ultrasound signal creating the potential to cause errors in a location determination by a system for determining three dimensional location of an object associated with a person at risk of falling down has been implemented in accordance with some embodiments of the disclosed subject matter.

FIG. 16A shows an example of a timing diagram showing signals transmitted and received by various devices in a system for determining three dimensional location of an object associated with a person at risk of falling down has been implemented in accordance with some embodiments of the disclosed subject matter.

FIG. 16B shows another example of a timing diagram showing signals transmitted and received by various devices in a system for determining three dimensional location of an object associated with a person at risk of falling down has been implemented in accordance with some embodiments of the disclosed subject matter.

### DETAILED DESCRIPTION

In accordance with various embodiments, mechanisms (which can, for example, include systems, methods, and media) for determining three dimensional location of an object associated with a person at risk of falling down are provided.

In some embodiments, the mechanisms described herein can cause ultrasound signals to be emitted from a relatively small number (e.g., often as few as three) of ultrasonic transducers installed in a known configuration around a space. In some embodiments, the ultrasonic signals can be received by a wearable monitoring device that is affixed to a person to be monitored, which can output a wireless or optical signal (e.g., a radio frequency signal, an infrared signal, a visible light signal, etc.) indicating that each ultrasonic signal was received. In some embodiments, the mechanisms described herein can receive the wireless signal (e.g., using one or more receiving devices that is local to the space) and determine the amount of time that elapsed between emission of each ultrasonic signal and reception of the corresponding wireless signal from the wearable monitoring device affixed to the person being monitored. In some embodiments, the mechanism described herein can determine the distance from each ultrasonic transducer to the wearable monitoring device based on the time elapsed between emission of the ultrasonic signal and reception of the wireless signal. After determining the distance to each ultrasonic transducer, the mechanisms described herein can determine the three dimensional location of the wearable monitoring device within the space using trilateration techniques. In some embodiments, if the mechanisms described herein determine that the wearable monitoring device is near the floor, the mechanisms can alert a caregiver or emergency services indicating that the person being monitored may have fallen on the floor.

While ultrasonic ranging systems are currently available, such systems are not suitable for measuring distances to objects (such as humans) that are poor reflectors of ultrasonic signals. For example, current ultrasonic ranging systems that are commercially available emit an ultrasonic pulse by an ultrasonic transducer, and measure the time required for the ultrasonic signal to return to the transducer (i.e., the round-trip time of the ultrasonic signal is measured). The range/distance to an object can be then calculated based on the one-half the round trip time and the speed at which the ultrasonic signal propagates through air. This approach of measuring the return time of the ultrasonic signal works well for “hard” objects that reflect the ultrasonic signal back to the transmitter, but does not work well for objects that are poor reflectors of ultrasonic signals (e.g., an object that absorbs or scatters the signal). For example, residents in an eldercare facility do not provide the desired natural reflection characteristics, and accordingly conventional ultrasonic ranging is poorly suited to measuring the distance to people (in addition to difficulties related to determining that the signal was in fact reflected from the person being monitored).

In some embodiments, the mechanisms described herein can cause an ultrasonic transducer (e.g., affixed in a known overhead location, such as the ceiling of a room, a corner between one or more walls and the ceiling of a room, a free standing structure such as a light pole, etc.) to emit an ultrasonic pulse. In some embodiments, the pulse can propagate through the space being monitored, and can be received by a wearable monitoring device that is affixed to a person being monitored (e.g., a resident of an elder care facility, a customer of an elder care service, etc.) that is configured to detect ultrasonic signals (e.g., using an ultrasonic transducer, a microphone, etc.). In some embodiments, in response to detection of the ultrasonic signal the wearable monitoring device can be activated (e.g., from a low power state) and/or can transmit a wireless radio frequency (RF) signal indicating that the ultrasonic signal was received. In some embodiments, the mechanisms described herein can receive the RF signal emitted by the wearable monitoring device (e.g., using a receiving device located within the transmitting range of the wearable monitoring device). In some embodiments, the mechanisms described herein can measure the time between when the ultrasonic signal was emitted to the time when the RF signal is received, which can be expected to be approximately equal to the amount of time between when the ultrasonic signal was transmitted to when the ultrasonic signal was received by the wearable monitoring device for the purpose of determining the distance from the ultrasonic transducer to the wearable monitoring device. For example, ultrasonic signals propagate at 343 meters per second (m/s) or 0.343 meters per millisecond (m/ms) (1,125 feet/second (ft/s) or 1.125 feet per millisecond (ft/ms)) in relatively dry air at 20 degrees Centigrade (° C.) (68 degrees Fahrenheit) (e.g., which is approximately equal to room temperature). As most spaces to be monitored in an elder care environment are likely to be relatively small (e.g., much smaller than 300 meters), propagation times can be expected to be on the order of milliseconds to tens of milliseconds. By contrast, the speed of light is approximately equal to 300,000,000 m/s or 300,000 m/ms, so the time due to propagation of the RF signal is negligible in most cases when compared to the ultrasonic propagation rate. In some embodiments, the mechanisms described herein can be configured to accurately resolve the distance to a wearable monitoring device from an ultrasonic transmitter to at least a resolution of 0.1 meters (3.93 inches) as this corresponds to a time difference of only about 0.1 ms or 100 μs. Using a relatively low frequency 1 megahertz (MHz) clock, this difference corresponds to 100 clock cycles. Note that various techniques can be used to account for variations in the speed at which ultrasound propagates due to environmental conditions, such as temperature and humidity. For example, the propagation time can be measured over a fixed distance (e.g., by detecting an ultrasonic signal from a particular ultrasonic transducer to an ultrasonic receiver at a known location), and that propagation time can be used to determine current propagation speed of the ultrasonic signals. The most recently measured propagation speed can be used in distance calculations.

Using two ultrasonic transducers, the two-dimensional (2D) location of a wearable monitoring device can be resolved to a circle or portion of a circle (i.e., an arc) where spheres centered on the transducers intersect. For example, in some embodiments, two ultrasonic transducers that are affixed in two upper corners of a space (e.g., near the ceiling of a room) can be connected to a local monitor which can independently activate each transducer. In some embodiments, the local monitor can cause a first ultrasonic transducer to emit a first ultrasonic pulse, and detect a wireless signal from a wearable monitoring device indicating the time at which the ultrasonic signal from the first transducer was received. After the wireless signal is received, the local monitor causes a second ultrasonic transducer to emit a second ultrasonic pulse, resulting in another wireless signal being received from the wearable monitoring device. In some embodiments, the time interval between emission of the two different pulses can be relatively short (e.g., less than 100 ms). The time delay (associated with the relatively slow ultrasonic propagation) from each of the two received wireless signals can be used to determine the distance from each transducer to the wearable monitoring device. Each distance can correspond to a radius of a sphere (or section of a sphere) centered on (or originating from) the corresponding ultrasonic transducer. Because only two distances are measured, the two spheres are likely to intersect at multiple points (except in cases where the wearable monitoring device is equidistant from the transducers), and these intersection points can be used to determine the location of the wearable monitoring device relative to the two transducers with an ambiguity caused by the multiple intersection points between the two spheres. A wearable monitoring device affixed to a resident occupying the space being monitored would likely exhibit different values of delays from each respective transducer. Accordingly, a simple 2D solution using two transducers is unlikely to be reliable on its own (although the ambiguity may be resolved by collecting additional data, such as barometric pressure, accelerometer data, data from a proximity detector, etc.).

In some embodiments, the mechanisms described herein can use a three dimensional (3D) approach that utilizes at least three ultrasonic emitting transducers. While three distance measurements are generally sufficient for determining the three dimensional location of an object (e.g., a remote wearable monitoring device as described herein), one or more additional ultrasonic transducers can be used to enhance reliability and fault tolerance. This can also facilitate more accurate location determinations. In some embodiments, each ultrasonic transducer in a particular space can be connected to a corresponding receiving device that is located within or near the space, which can activate each transducer independently and sequentially. For example, as was described above in connection with the 2D approach, the receiving device can cause each transducer to emit an ultrasonic pulse which signal impinges on the wearable monitoring device affixed to a person to be monitored. In some embodiments, the first pulse can be received by the wearable monitoring device and can cause the wearable monitoring device to transition from a low power state and transmit a wireless RF signal that is received by the receiving device. In some embodiments, the receiving device can determine the propagation time of the ultrasonic signal emitted by the first transducer, and thus the distance from the transducer to the wearable monitoring device, by measuring the time that elapses between when the ultrasonic pulse was triggered and when the RF signal was received. The receiving device can then cause the next ultrasonic transducer to emit a next ultrasonic pulse, which is received by the wearable monitoring device (which can be in a high power state after receiving the first ultrasonic pulse) causing the wearable monitoring device to emit a wireless signal. Distance information from all (e.g., three or more) transducers in the space can be used to determine a relatively precise location of the person to whom the wearable monitoring device is affixed (note that there may still be some ambiguity due to small measurement differences, but this ambiguity would be negligible compared to the distances from the transducers to the wearable monitoring device). This location information can then be used by the receiving device and/or a centralized wearable monitoring device to determine whether the person is in a normal position (e.g., standing, sitting, or laying on a bed) or on the floor.

In some embodiments, if more than two ultrasonic transducers (e.g., three or four such transducers) are affixed in the three or four locations around the top of a space (e.g., in the corners of a room), the mechanisms described herein can calculate (e.g., by triangulation) a simulated “ultrasonic surface” 0.3 to 0.6 meters (e.g., 1-2 feet) above the floor. If the person's calculated position is beneath this simulated “ultrasonic surface,” then the mechanisms can determine that the person is on or close enough to the floor that an appropriate warning can be sent to a caregiver or emergency services.

In some embodiments, the mechanisms described herein can use a threshold as an initial criterion to determine whether a wearable monitoring device is near the floor. For example, each ultrasonic transducer can be associated with a threshold distance based on the distance between that ultrasonic transducer and the floor. In such an example, the threshold distance can a predetermined amount (e.g., 0.3 to 0.6 meters) less than the height of the ultrasonic transducer with respect to the floor. Note that, if the ultrasonic transducers are all mounted at the same height, the threshold can be the same for each transducer. In some embodiments, the mechanisms described herein can compare each distance to a predetermined threshold, and if none of the distances exceeds the threshold, the mechanisms can determine that the wearable device is not near the floor. For example, in some embodiments, if there are at least three transceivers monitoring a relatively small space (e.g., all areas of the space are within the threshold distance of at least one of the transceivers), and the distance to each of the transceivers is less than the threshold, the mechanisms described herein can determine that the wearable monitoring device is not near the floor.

In some embodiments, the pulsing of all the ultrasonic transducers around a space to be monitored can be accomplished in less than half a second (500 ms), and can be repeated at regular and/or irregular intervals. For example, after 10-20 seconds has elapsed, the mechanisms described herein can cause a first ultrasonic transducer to emit a first pulse, wait for an RF signal from a wearable monitoring device indicating reception of the first pulse and/or wait for a predetermined amount of time (e.g., 100 ms), and then cause a second ultrasonic transducer to emit a second pulse, etc., until all the ultrasonic transducers have emitted a pulse. In some embodiments, by emitting ultrasonic signals within a relatively short time window with relatively long time windows between, wearable monitoring devices that are configured to be affixed to persons being monitored can operate with a relatively low duty cycle. This can in turn reduce power consumption, which can facilitate reducing the battery size and overall size of the wearable monitoring device and/or increase the battery life of the wearable monitoring device. For example, a wearable monitoring device that is in a high power state for a half second every 10 seconds is equivalent to a 0.05 (5%) on-time duty cycle for the wearable monitoring device. As another example, a wearable monitoring device that is in a high power state for a half second every 20 seconds is equivalent to a 0.025 (2.5%) on-time duty cycle for the wearable monitoring device.

In some embodiments, the wireless signal that is emitted by the wearable monitoring device after reception of each ultrasonic pulse can have a relatively simple payload. For example, the wireless signal can be a non-modulated RF signal burst at a particular frequency (e.g., which can vary between wearable monitoring devices as a mechanism for distinguishing different devices) with a pulse width that matches the pulse width of the ultrasonic device. In such an example, the pulse width can be on the order of 1-25 ms, and in some cases can be used as a mechanism for differentiating different ultrasonic transducers (e.g., transducers in a first room can be configured to have a first pulse width, while transducers in an adjacent room can be configured to have a different pulse width). In such an example, the non-modulated RF signal can be an RF signal at a particular frequency without any particular modulation applied to the signal (e.g., without an amplitude or frequency modulation applied).

In some embodiments, the wearable monitoring device can include a payload in the signal to convey additional information with the wireless signal. For example, the wearable monitoring device can include in the wireless signal identifying information of the wearable monitoring device and/or person associated with the wearable monitoring device, such as a serial number of the wearable monitoring device and/or identifying information (e.g., a resident identification code) of the person. In some such examples, such information can be conveyed in a nominal few bytes (e.g., one or two bytes). As another example, the wearable monitoring device can include in the wireless signal information indicative of whether the wearable monitoring device is being worn properly (e.g., as a compliance indication), which can be formatted to be transmitted using as few as one or two bits, or up to a few bytes. In a more particular example, such information can be a temperature output by a temperature sensor of the wearable monitoring device, or an indication of whether the temperature is within a predetermined range (e.g., a range near body temperature). As another more particular example, such information can be an on-the-body proximity sensor output.

In some embodiments, the wearable monitoring device can incorporate additional sensors that can be used to determine whether the wearable monitoring device is near the floor of a space (e.g., other “fall on the floor” or “fallen on the floor” sensors). Such additional sensors can provide redundancy and robustness to a detection of a fall event. For example, in some embodiments, the wearable monitoring device can include a barometric pressure sensor. As another example, in some embodiments, the wearable monitoring device can include a proximity-to-the-floor sensor that is activated when in proximity to a device placed in a location to be sensed, such as a wire running under the floor (e.g., under carpet, embedded in concrete, etc.). In some embodiments, the wearable monitoring device can include in the wireless signal information indicative of the state of such additional sensors, such as a pressure, an indication of whether a proximity sensor is currently active, etc. In some embodiments, such additional information can be conveyed using a few bytes (e.g., 3-5 bytes).

In some embodiments, a wireless signal emitted by the wearable monitoring device (e.g., in response to an ultrasonic pules, after a predetermined period of time, etc.) can include 8-10 bytes of information, which can be transmitted as few as 2-3 times per minute resulting in a very low data rate that could be communicated very reliably. In some embodiments, if such information is sent in response to every ultrasonic pulse it can be sent at least 10-20 times per minute, but this still amounts to less than about 200 bytes per minute.

In some embodiments, a process for determining whether a person wearing a wearable monitoring device has fallen on the floor can be carried out by one or more devices that are not worn on the body. For example, the wearable monitoring device can be a relatively simple, low power, small, reliable, robust, and comfortable-to-wear device that includes one or more sensors, a processor with relatively little computing power, and hardware that can be used to transmit a wireless signal. In such an example, the wearable monitoring device can report information which is used by one or more other devices (e.g., a local monitor and/or centralized wearable monitoring device) to determine whether a person may have fallen on the floor.

In some embodiments, if the wearable monitoring device is configured to be comfortable and easy to use (e.g., by not requiring frequent recharging or battery changes, or any active participation by the wearer) it may increase use by the persons to be monitored.

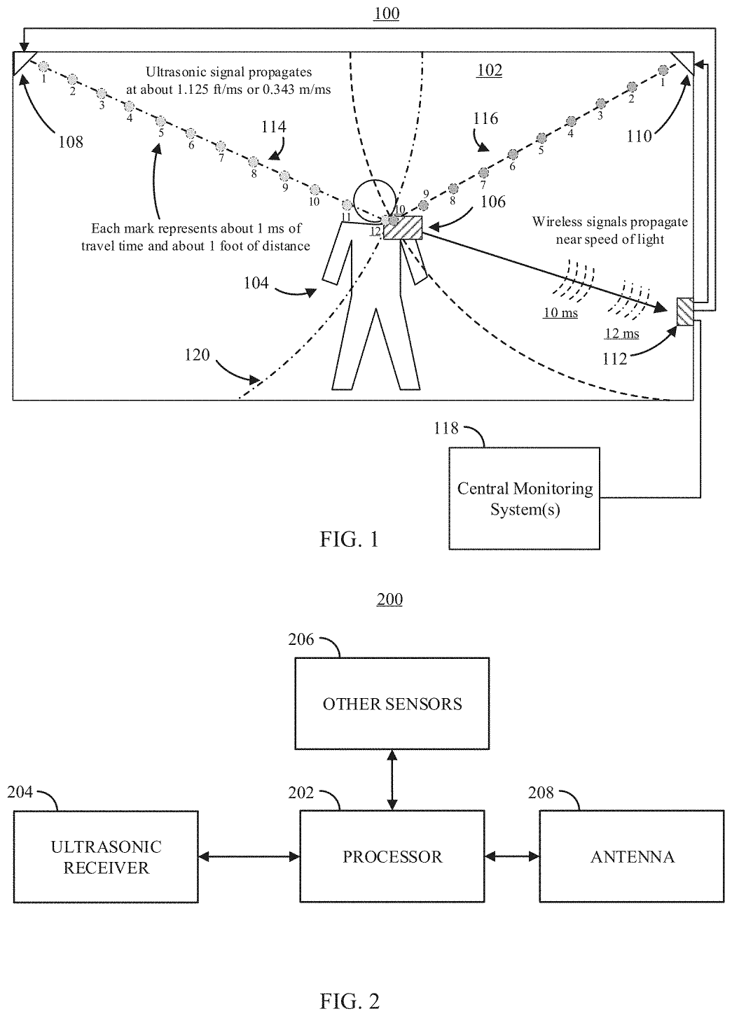

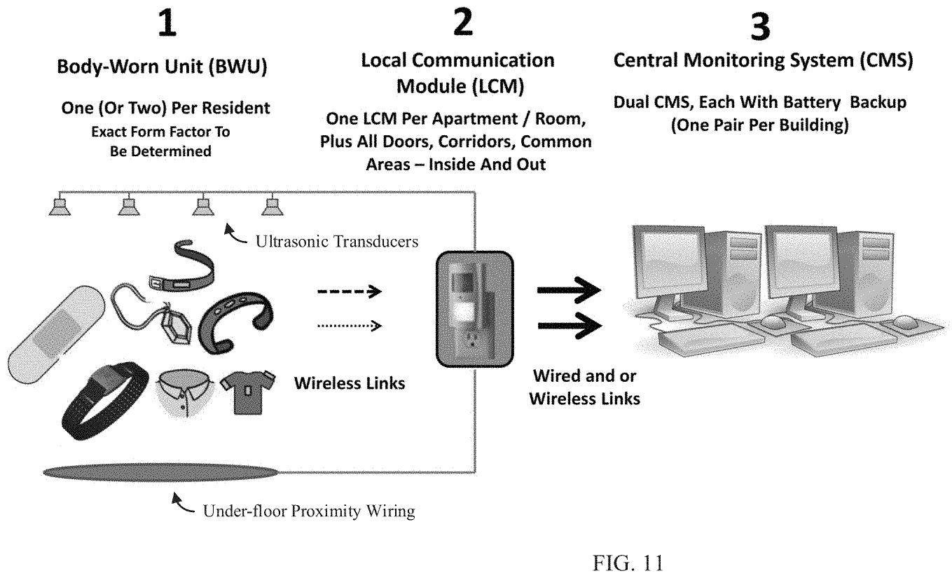

FIG. 1 shows an example 100 of a system for determining three dimensional location of an object associated with a person at risk of falling down in accordance with some embodiments of the disclosed subject matter. As shown in FIG. 1, a room 102 can be occupied by a person 104, who may be an elderly resident of an elder care facility or an elderly person in a home environment that is utilizing a monitoring service. A remote monitor 106 (sometimes referred to herein as a wearable monitoring device) can be affixed to person 104 at a location that is normally not near the floor, such as the shoulder, head, neck, chest, waist, hip, etc. In some embodiments, remote monitor 106 can be affixed to the wrist or hand of person 104, but this may result in some false positives (e.g., where the user reaches down to retrieve something from the floor, and has not fallen on the floor). As described below in connection with FIG. 11 and elsewhere, remote monitor 106 can be implemented using multiple styles and/or form factors.

In some embodiments, room 102 can be configured with multiple ultrasonic transducers 108 and 110, which in system 100 are located at the corner where the ceiling and wall meet. However, this is merely an example and ultrasonic transducers can be located in other locations, such as affixed to the ceiling or wall away from a corner. In some embodiments, ultrasonic transducers 108 and 110 can be controlled by a local monitor 112 that is located in proximity to room 102. In the example shown in FIG. 1 local monitor 112 is affixed to the wall within room 102, but this is merely an example, and local monitor 112 can be located in any suitable location.

In some embodiments, ultrasonic transducers 108 and 110 can be electrically connected to local monitor 112 through any suitable conductor. For example, in some embodiments, ultrasonic transducers 108 and 110 can be connected directly or indirectly to local monitor 112 with low voltage wiring. As another example, ultrasonic transducers 108 and 110 and local monitor 112 can be coupled to a local electric power grid (e.g., wiring that connects wall sockets, light fixtures, etc., to mains power) and can communicate using one or more power line communication (PLC) techniques. As yet another example, in some embodiments, local monitor 112 can communicate with ultrasonic transducers 108 and 110 using one or more wireless communication techniques, and ultrasonic transducers 108 and 110 can be connected to the local electric power grid or powered using an alternate source such as a battery, a solar cell, etc.

In some embodiments, local monitor 112 can cause ultrasonic transducers 108 and 110 to emit ultrasonic signals periodically (at regular and/or irregular intervals) which may or may not carry information (e.g., the ultrasonic signal can be a non-modulated signal that does not carry any additional information). For example, as described above, local monitor 112 can cause ultrasonic transducer 108 to emit a first ultrasonic pulse 114 (represented as a dashed line with alternative short and long dashes) at a first time, and can cause ultrasonic transducer 110 to emit a second ultrasonic pulse 116 (represented as a dashed line with only long dashes) a short time later (e.g., 20 to 100 ms later). Note that although ultrasonic pulses 114 and 116 are shown as straight lines directed from ultrasonic transducers 108 and 110 to remote monitor 106 this is merely to illustrate principles of the disclosed subject matter, and the pulses can be expected to radiate from ultrasonic transducers 108 and 110 in a conical or spherical shape.

As shown in FIG. 1 using circles superimposed over ultrasonic pulses 114 and 116, each millisecond the ultrasonic pulse can be expected to propagate by roughly ⅓ of a meter (nominally 1 foot for ease of explanation) through room 102. In the example shown in FIG. 1, first ultrasonic pulse 114 propagates for roughly 12 ms before it is detected by remote monitor 106, and ultrasonic signal 116 propagates for roughly 10 ms before it is detected by remote monitor 106. In some embodiments, in response to detecting ultrasonic pulse 114, remote monitor 106 can emit a first wireless signal which is detected by local wearable monitoring device 112 about 12 ms after pulse 114 was emitted. As local wearable monitoring device 112 is both controlling the emission timing of pulse 114 and detecting the wireless signal from remote monitor 106, local wearable monitoring device 112 can determine the propagation time of pulse 114, which can facilitate determination of a distance between ultrasonic transducer 108 and remote monitor 106. As shown by arc 120 in FIG. 1, which represents a radius of about 4 meters (12 feet) from ultrasonic transducer 108, knowing the propagation time before detection by remote monitor 106 limits the possible locations of remote monitor 106 to a point along arc 120. In the example of FIG. 1, arc 120 intersects an arc representing a 10 ms propagation time. The intersection of these arcs can be used to determine the location of remote monitor 106 within room 102. However, this is merely a 2D example, and in a 3D environment arc 120 represents a portion of a sphere surrounding ultrasonic transducer 108. Accordingly, the two data points represented in FIG. 1 can be used to determine that remote monitor 106 is somewhere along the intersection of the two spheres surrounding ultrasonic transducers 108 and 110, which in this case only intersect away from the floor (in an arc extending from remote monitor 106 to the ceiling. In this example, then, it can be determined with only two data points that remote monitor 106 is not near the floor, and accordingly that person 106 has not fallen on the floor as no possible location of remote monitor 106 is near the floor. Note that although propagation times are described herein as being recorded at a resolution of milliseconds, these are merely examples used to avoid overcomplicating the description. In some embodiments, the mechanisms described herein can record transmission and/or arrival times to any suitable precision. For example, in some embodiments, each time associated with an ultrasound transmission and/or a time at which a wireless signal is received from a remote monitor can be recorded to a precision of tens of microseconds to hundreds of microseconds (e.g., half milliseconds). This can permit the mechanisms described herein to calculate distances more precisely, such as a resolution on the order of millimeters (e.g., a resolution of 3.43 mm with times recorded to the tens of microseconds) to about a fifth of a meter (e.g., a resolution of 0.17 meters with time recorded to the half-millisecond). In some embodiments, a delay associated with remote monitor 106 detecting and processing an ultrasound signal and generating a responsive wireless signal, and/or a delay associated with detecting and processing the wireless signal can be accounted for when determining a distance between a particular ultrasonic transducer and remote monitor 106. For example, in some embodiments, an average amount of time taken for a particular remote monitor 106 and/or a group of remote monitors 106 (e.g., a specific groups of remote monitors associated with a particular facility, a group of remote monitors tested by a manufacturer, etc.) to detect and process an ultrasound signal and/or emit a wireless signal can be determined (e.g., during a calibration process), and the average amount of time can be used when determining the propagation time of the ultrasound signal. In a more particular example, the average detection and processing time can be subtracted from a total time elapsed between emission of the ultrasound signal (e.g., ultrasound pulse 114) and detection of the wireless signal. As another example, in some embodiments, an average amount of time taken for a particular local monitor 106 and/or a group of local monitors 106 (e.g., a specific groups of local monitors associated with a particular facility, a group of local monitors tested by a manufacturer, etc.) to detect and process a wireless signal can be determined (e.g., during a calibration process), and the average amount of time can be used when determining the propagation time of the ultrasound signal. Note that the “average” can be the mean, the median, the mode, or some other value that represents some amount of delay that can be used to refine a calculation of a propagation time of an ultrasound signal (e.g., one half of a standard deviation below the mean, one standard deviation below the mean, etc.).

In some embodiments, local monitor 112 can be coupled to a central monitoring system 118, which can be coupled to other local monitors 112 at other locations within a facility in which room 102 is located and/or to local monitors 112 in other locations (e.g., other homes, other facilities, etc.). In some embodiments, local monitor 112 can be electrically connected to central monitoring system 118. For example, central monitoring system 118 can be connected directly or indirectly to local monitor 112 with low voltage wiring. As another example, local monitor 112 and central monitoring system 118 can be coupled to a local electric power grid (e.g., wiring that connects wall sockets, light fixtures, etc., to mains power) and can communicate using one or more power line communication techniques. In some embodiments, local monitor 112 can communicate with central monitoring system 118 using one or more wireless communication techniques.

In some embodiments, central wearable monitoring device 118 and/or local monitor 112 can be used to implement one or more additional techniques for determining that a person has fallen on the floor, which are not shown in FIG. 1, but some of which are described herein. For example, a local monitor can be installed in every apartment or room that is to be monitored, as well as at all doorways, corridors, and common areas (e.g., outside patios or other resident green living spaces) that are to be monitored. In addition to ultrasonic transducers, under-floor proximity wiring can be coupled to the local monitor(s), as well as doorway and outside proximity wiring.

FIG. 2 shows an example 200 of a block diagram of a system for determining three dimensional location of an object associated with a person at risk of falling down in accordance with some embodiments of the disclosed subject matter. As shown in FIG. 2, in some embodiments, remote monitor 106 can include a processor 202 which can be coupled to one or more ultrasonic receives 204, such as a ultrasonic transducer in receive mode or a broadband microphone. Additionally, in some embodiments, processor 202 can be coupled to one or more other sensors 206, such as a temperature sensor, a barometric pressure sensor, an accelerometer, a proximity wire sensor, etc. In some embodiments, processor 202 can be coupled to an antenna 208 that processor 202 can utilize to transmit wireless signals (e.g., in response to detection of an ultrasonic pulse).

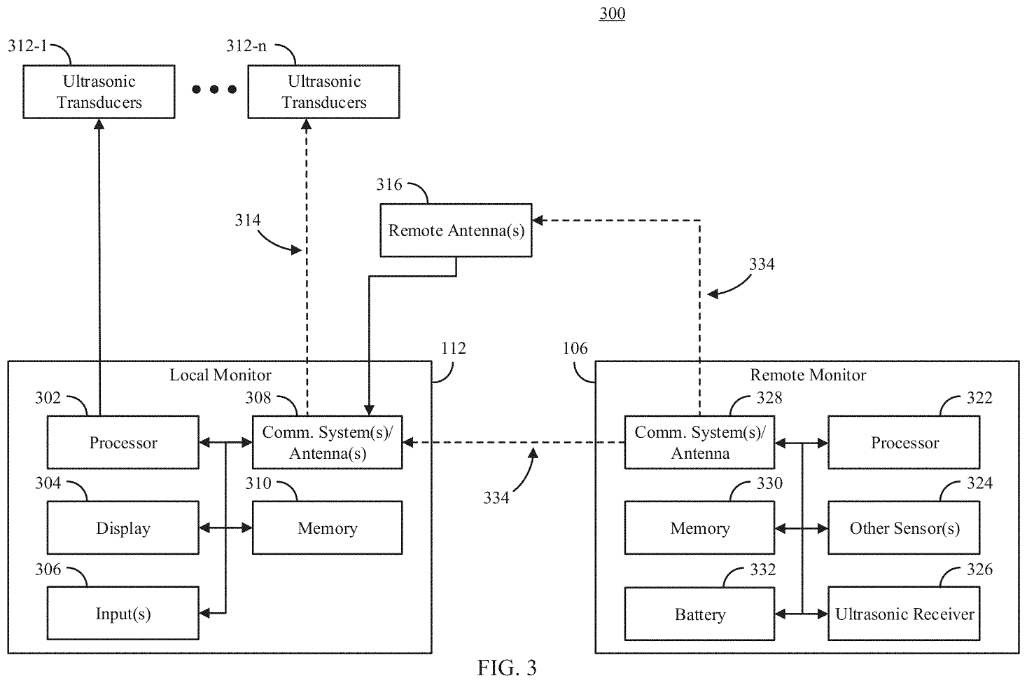

FIG. 3 shows an example 300 of hardware that can be used to implement remote monitor 106 and local monitor 112 of FIG. 1 in accordance with some embodiments of the disclosed subject matter. As shown in FIG. 3, in some embodiments, remote monitor 106 can include a processor 322, one or more sensors 324 (and/or hardware configured to receive signals from one or more sensors), one or more ultrasonic receivers 326 (and/or hardware configured to receive signals from one or more ultrasonic receivers), one or more communication systems 328 which can include one or more antennas or other devices that can be used to transmit a wireless signal (e.g., one or more light sources that can be used to send a light-based wireless signal), memory 330, and/or a battery 332 (and/or other power source).

In some embodiments, processor 322 can be any suitable hardware processor or combination of processors, such as a microcontroller (MCU), a field programmable gate array (FPGA), an application-specific integrated circuit (ASIC), a central processing unit (CPU), a graphics processing unit (GPU), etc. In some embodiments, communications system(s) 318 can include any suitable hardware, firmware, and/or software for communicating information to local monitor 112, over communication link 334, over any other suitable communication link or combination of communication links, and/or over any suitable communication network or combination of networks. For example, communications system(s) 328 can include one or more transceivers, one or more communication chips and/or chip sets, etc. In a more particular example, communications system(s) 328 can include hardware, firmware and/or software that can be used to communicate data over a coaxial cable, a fiber optic cable, an Ethernet connection, a USB connection, to establish a Wi-Fi connection, a Bluetooth connection, a cellular connection, etc.

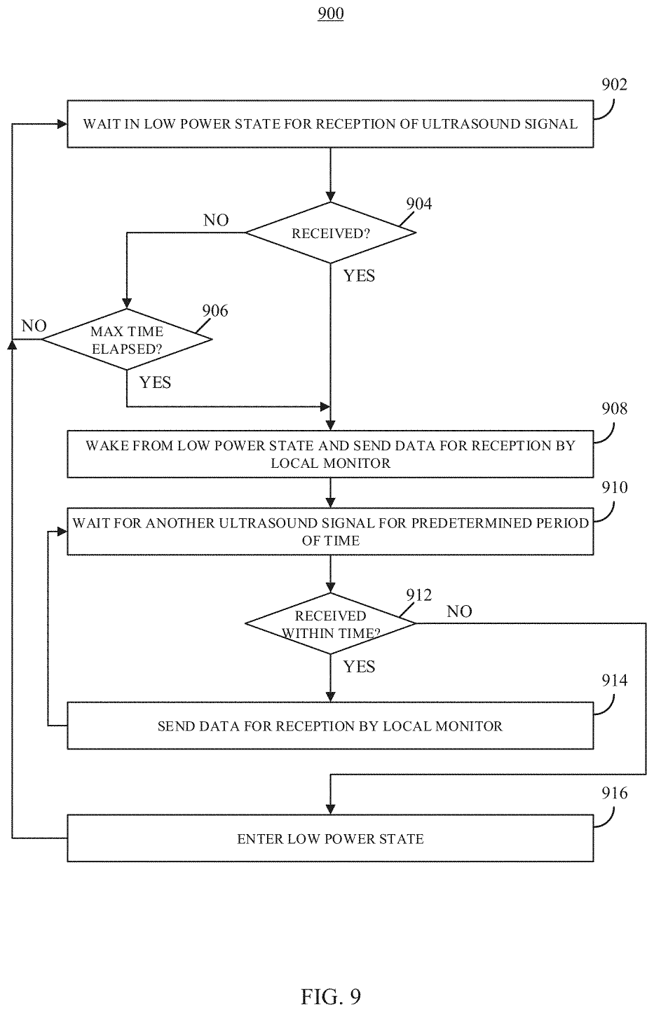

In some embodiments, memory 330 can include any suitable storage device or devices that can be used to store instructions, values, etc., that can be used, for example, by processor 322 to receive signals via ultrasonic receiver 326 and/or one or more other sensors 324, to encode signals received via analog sensors ultrasonic receiver 326 and/or one or more other sensors 324, to store the encoded signals in memory 330, and/or transmit the encoded signals to local monitor 112 via communications system(s) 328, etc. Memory 330 can include any suitable volatile memory, non-volatile memory, storage, or any suitable combination thereof. For example, memory 330 can include RAM, ROM, EEPROM, one or more flash drives, one or more hard disks, one or more solid state drives, one or more optical drives, etc. In some embodiments, memory 330 can have encoded thereon a program for controlling operation of processor 322 to detect ultrasonic signals, emit wireless signals indicating detection of one or more ultrasonic signals, received and/or record physiological and/or environmental signals for communication to local monitor 112, etc. In some such embodiments, processor 322 can execute at least a portion of the program to execute at least a portion of process 900 as described below in connection with FIG. 9.

In some embodiments, local monitor 112 can include a processor 302, a display device 304, one or more inputs 306, one or more communication system(s) 308 which can include one or more antennas for detecting wireless signals emitted by remote monitor(s) 106 (or devices for receiving other types of wireless signals, such as a sensor that is configured to detect light-based wireless signals), and/or memory 310. In some embodiments, processor 302 can be any suitable hardware processor or combination of processors, such as a CPU, a GPU, MCU, FPGA, ASIC, etc. In some embodiments, display 304 can include any suitable display devices, such as one or more indicator lights, a seven-segment display (e.g., implemented using liquid crystal display (LCD) techniques, light emitting diode (LED) techniques, etc.), a touchscreen, etc. In some embodiments, inputs 306 can include any suitable input devices and/or sensors that can be used to receive user input, such as one or more hardware or software buttons, a touchscreen, a microphone, etc.

In some embodiments, communications system(s) 308 can include any suitable hardware, firmware, and/or software for receiving communications from remote monitor 106, for communicating with a central monitoring system, and/or one or more ultrasonic transducers 312-1 to 312-n and/or for communicating over any other suitable communication links and/or communication networks. For example, communications system(s) 308 can include one or more transceivers, one or more communication chips and/or chip sets, etc. In a more particular example, communications systems 308 can include hardware, firmware and/or software that can be used to establish a coaxial connection, a fiber optic connection, an Ethernet connection, a USB connection, a Wi-Fi connection, a Bluetooth connection, a cellular connection, etc. In some embodiments, one or more ultrasonic transducers 312 can be electrically coupled to processor 302 through one or more connectors or through a hardwired connection to processor 302 (e.g., through the use of solder, a fastening device, etc.). Additionally or alternatively, in some embodiments, communication system 308 can establish a connection 314 to one or more ultrasonic transducers which can be a wired connection (e.g., through a power-line network using PLC techniques) or wireless (e.g., in the RF band, using light, etc.).

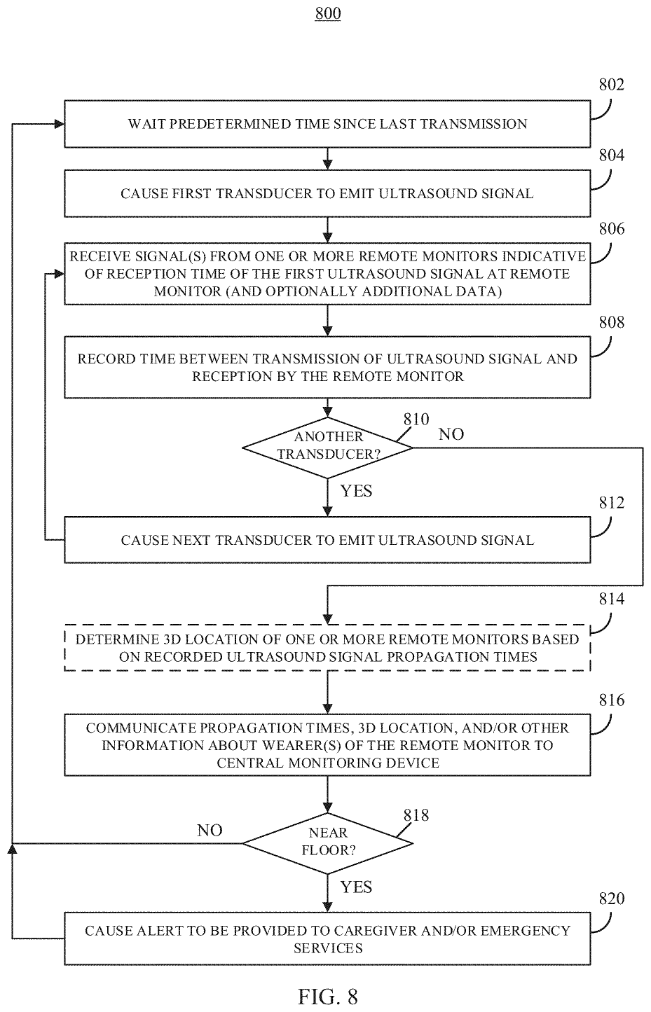

In some embodiments, memory 310 can include any suitable storage device or devices that can be used to store instructions, values, etc., that can be used, for example, by processor 302 to present content using display 304, to communicate with one or remote monitors (e.g., remote monitor 106). Memory 310 can include any suitable volatile memory, non-volatile memory, storage, or any suitable combination thereof. For example, memory 310 can include RAM, ROM, EEPROM, one or more flash drives, one or more hard disks, one or more solid state drives, one or more optical drives, etc. In some embodiments, memory 310 can have encoded thereon a computer program for controlling operation of processor 302. In some such embodiments, processor 302 can execute at least a portion of the computer program to receive encoded signals from remote monitor 106, to decode the encoded data, etc. In some embodiments, processor 302 can execute one or more portions of process 800 described below in connection with FIG. 8. In some embodiments, local monitor 112 can be implemented using suitable computing device or combination of computing devices, such as a personal computer, a laptop computer, a tablet computer, a smartphone, a wearable computer, a server, etc., in addition to a special purpose device, such as a “wall wart” configured to implement the functions of local monitor 112.

In some embodiments, one or more antennas 316 can be installed at various points within a space (e.g., room 102), and remote antennas 316 can be coupled to local monitor 112 (e.g., through one or more wires), one or more wireless connections, etc. For example, in a room, one or more remote antennas 316 can be installed behind each baseboard. As another example, one or more remote antennas 316 can be installed under flooring of a room (e.g., under carpet, under wood flooring, under tile, embedded in concrete, etc.) In some embodiments, coupling local monitor 112 to one or more remote antennas 316 can increase a likelihood that a wireless signal emitted by remote monitor 106 is detected. For example, if remote monitor 106 is affixed to a subject's upper chest, and the subject falls such that remote monitor 106 is between the subject's body and the floor, one or more remote antennas 316 may be better positioned with respect to remote monitor 106 to detect the wireless signal than would the internal antenna of remote monitor 112.

In some embodiments, each local monitor 112 can communicate individually with each ultrasonic transducers 312 installed in proximity of the space to be monitored using one or more techniques. For example, if one or more ultrasonic transducers 312 are wall-powered, local monitor 112 can transmit a coded pulse into the building's power wiring, with each pulse containing identifying information for a particular transducer. In such an example, each ultrasonic transducer that is connected to wall power can be configured to monitor the power line for such transmissions, and decode and respond when a pulse includes identifying information corresponding to the ultrasonic transducer. As another example, if one or more ultrasonic transducers 312 are powered using a distributed system of low-voltage wiring, a similar approach to that described for power wiring can be used. Additionally or alternatively, if one or more ultrasonic transducers 312 are powered using low voltage wires that are specific to that ultrasonic transducer, a unique alert code may not be needed as local monitor 112 can communicate directly with each transducer through the dedicated wiring. As yet another example, if one or more ultrasonic transducers 312 are powered using a battery (or other mobile power source), which can reduce installation costs by obviating the need to install additional wiring in each space, local monitor 112 can transmit coded infrared signals (or other wireless signals), which can be monitored by the individual ultrasonic transducers. Additionally or alternatively, local monitor 112 can transmit instructions to ultrasonic transducers using RF signals, with each ultrasonic transducer monitoring and responding to RF signals addressed to that ultrasonic transducer.

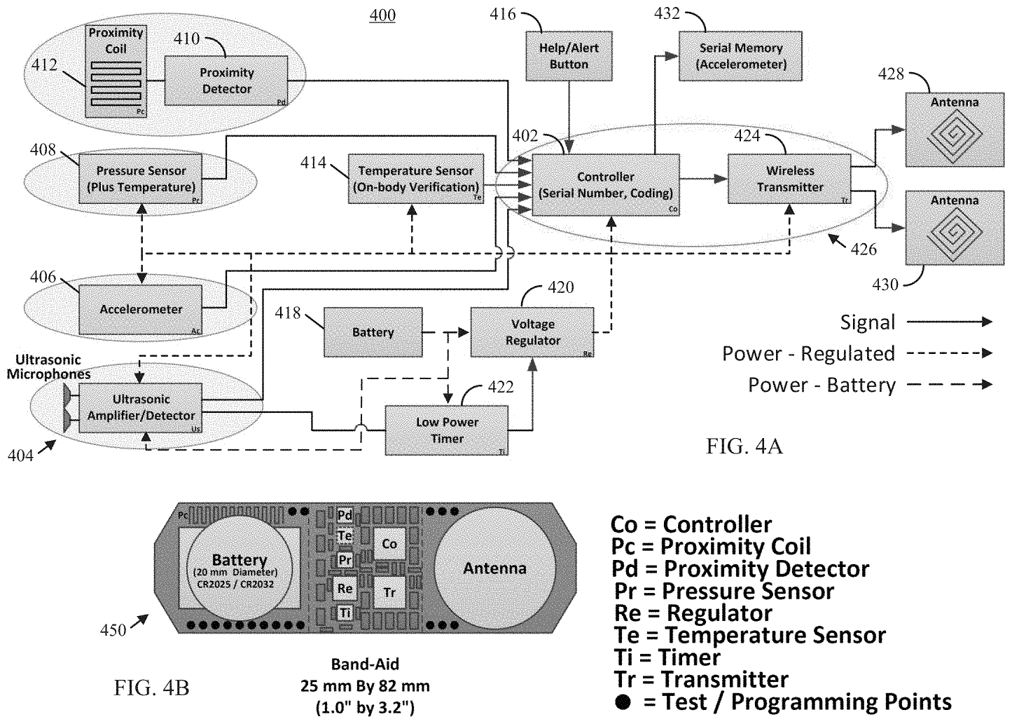

FIG. 4A shows an example 400 of hardware components that can be used to implement a portion of remote monitor 106 of FIG. 1 in accordance with some embodiments of the disclosed subject matter. In some embodiments, hardware 400 can include a controller 402 that can coordinate operation of hardware 400. As shown in FIG. 4A, remote monitor 106 can be implemented using various sensors, which are illustrated on the left of FIG. 4A, can be coupled to controller 402. For example, in some embodiments, hardware 400 can include an ultrasonic detector 404, which can be implemented using one or more miniature ultrasonic transducers, one or more wide-bandwidth high-sensitivity microphones, etc. In some embodiments, multiple transducers (or microphones, etc.) can be placed at different positions on remote monitor 106 to increase the likelihood that at least one of the transducers detecting a given ultrasonic signal. As another example, hardware 400 can include an accelerometer 406 which can be used to determine an orientation of hardware 400 (e.g., by determining which direction corresponds to the acceleration due to gravity), movements of a wearer, etc. As yet another example, hardware 400 can include a pressure (and/or external temperature) sensor 408, which can be used to determine whether a pressure in a space has increased, which may indicate that a wearer has fallen on the floor. As still another example, hardware 400 can include a proximity detector 410 coupled to a proximity coil 412. In such an example, proximity detector 410 can detect when a signal is picked up by proximity coil 412 that is indicative of proximity to a particular proximity wire(s) installed in a space.

In some embodiments, hardware 400 can include a temperature sensor 414 that is configured to determine whether hardware 400 is currently worn. For example, temperature sensor 414 can be implemented such that is near a subject's body when remote monitor 106 is being worn, and can output a value indicative of the sensed temperature and/or a value indicative of whether the sensed temperature corresponds to an expected temperature of remote monitor 106 when worn (e.g., versus when removed). In such an example, temperature sensor 414 can output a temperature value (e.g., in degrees Celsius, Kelvin, Fahrenheit, etc.) to any suitable precision (e.g., zero decimal places, one decimal place, etc.), or a binary indication of whether the temperature is within a particular range (e.g., over 30° C., between 30 and 40° C., etc.).

In some embodiments, hardware 400 can include an input 416 coupled to controller 402, and actuation of input 416 can cause controller 402 to exit a low power state and/or cause controller 402 to transmit an alert indicating that a wearer of remote monitor 106 may be in distress (e.g., as a wireless signal using one or more antennas). For example, in response to actuation of input 416, controller 402 can transmit a help message that can be received by local monitor 112.

In some embodiments, hardware 400 can include a battery 418 that can provide power to one or more other components of remote monitor 106. In some embodiments, battery 418 can be coupled to a voltage regulator 420 that can control a voltage and/or current of power distributed to components of hardware 400. Additionally, in some embodiments, battery 418 can be coupled to ultrasonic detector 404 and/or a low power timer 422 to provide power when remote monitor 106 is in a low power state. For example, battery 418 can power ultrasonic detector 404 during a low power state such that ultrasonic detector 404 can detect an ultrasonic signal. In a more particular example, a remote monitor 106 implemented using hardware 400 can be in a very low power state normally, with the only circuitry consuming power being low power timer 422 (e.g., which can have a single-digit microampere current draw) and a low duty cycle (e.g., on the order of 1-5%) controlled low power front-end gain stage (e.g., which can have a low tens of microamperes current draw) used by ultrasonic detector 404. In such an example, the remainder of the circuitry can be powered down or otherwise in a low power state a large majority of the time.

In some embodiments, various events can occur that cause hardware 400 to enter a higher power state. For example, activation of input 416 can cause hardware 400 to “awaken” from a low power state (sometimes referred to as a “sleep” or “idle” mode). As another example, a signal from proximity coil 412 can cause hardware 400 to “awaken” from the low power state, such as when a wearer passes through a doorway (or other entrance or exit), or comes into proximity to a coil in the floor (e.g., if the wearer were to fall or lay down). Note that, in some embodiments, proximity coil 412 can be powered remotely (e.g., by corresponding proximity coils installed in a space). In such embodiments, proximity coil 412 can be configured to output a wake signal when an appropriate signal is received, without receiving power from a battery. Techniques that use proximity coils to determine whether a wearer has fallen are described in more detail in International Patent Application Publication No. WO 2017/223339 (international application no. PCT/US2017/038794), which is hereby incorporated by reference herein in its entirety. As yet another example, ultrasonic detector 404 can output a signal in response to an ultrasonic event (which would typically occur on the order of every 10 to 30 seconds, such as every 10 seconds, every 15 seconds, every 20 seconds, etc.) that can cause hardware 400 to “awaken” from the low power state. As still another example, low power timer 422 (or another low power device coupled to low power timer) can output a signal to cause hardware 400 to “awaken” from the low power state periodically (e.g., at regular or irregular intervals) such as every 10 to 30 seconds from a last time hardware 400 was in a higher power state. In some embodiments, operating in a low power state for a vast majority of the time can facilitate implementations of remote monitor 106 that are relatively small and do not require frequent battery changes or charging (e.g., charging can be performed using wireless techniques and/or can be performed once per week or less).

In some embodiments, when an activation event occurs (e.g., detection of an ultrasonic signal), remote monitor 106 can awaken and transmit a signal indicating that an event has occurred. For example, in response to receiving an ultrasonic signal in the low power state, remote monitor 106 can awaken and transmit a signal indicative of reception of the ultrasonic signal and/or identifying information of remote monitor 106 (e.g., a device serial number). In some embodiments, if the event is not reception of an ultrasonic signal, remote monitor 106 can transmit a signal indicative of the event that has occurred and/or indicating that the signal being transmitted is not in response to an ultrasonic signal. In some embodiments, after an activation event occurs, remote monitor 106 can remain in a higher power state for a predetermined amount of time to allow for detection of ultrasonic signals that can be expected after most activation events. In some embodiments, values from (or derived from) proximity detector 410, pressure sensor 408, accelerometer 406 (which can be used to determine the wearer's orientation to attempt to verify whether the wearer is on the floor), and temperature sensor 414 can also be wirelessly communicated with a signal emitted in response to one or more of the additional ultrasonic signals. In some embodiments, remote monitor 106 can remain active on the order of about 0.1 seconds to 1 second, as all ultrasonic signals (or at least enough to determine a position of remote monitor 106) can be expected to be received within that period of time.

In some embodiments, by only waking in response to particular activation events that can be expected to occur relatively infrequently (e.g., on the order of a few than five times per minute), the duty cycle of remote monitor 106 can be kept relatively low, which in turn can minimize power consumption. For example, 0.5 seconds of “on” time every 10 seconds has a 0.05 (5%) on time duty cycle, and 0.5 seconds of “on” time every 20 seconds has a 0.025 (2.5%) on time duty cycle. As another example, a 0.5 second “on” time every 30 seconds has a 0.017 (1.7%) on time duty cycle. Assuming a 20 second communication interval, and a relatively large current draw of 50 mA during transmission, the resulting battery capacity requirement for a one week run time can be estimated as: Transmit time per minute (3 transmit at 0.5 second/transmission: =1.5 s; Transmit time per hour: (above*60)=90 s (1.5 minutes); Transmit time per day: (above*24), =2,160 s (36 minutes); Transmit time per week: (above*7), 15,120 s (252 minutes/4.2 hours); Battery capacity for one week: 4.2 hours*50 mA+210 mAh. A relatively small 20 mm diameter by 3.2 mm thick coin cell (e.g., often identified as a #2032 battery) generally has a rate capacity of 240 mAh, more than needed for this 210 mAh one week run time. A longer run time (e.g., on the order of a week) can reduce the number of battery replacements needed to be conducted by the wearer and/or a caregiver. In addition, this 240 mAh at 3 volts results in a total of 0.72 W of total power consumption over a one week period, which in turn results in nominally 100 mW of power consumption per day. Such a relatively low power consumption can be compensated for using one or more energy harvesting techniques that do not require actively changing a battery or placing a device into contact with a charging device (e.g., charging can take place as a wearer performs normal activities). For example, a “recharge” coil placed under a mattress/mattress pad of a wearers bed can allow up to nominal 7-8 hours of short-range recharge capability every day.

Note that the above description is intended to be a reasonable worst case scenario, and remote monitor 106 can be implemented to consume less power in some cases. Alternatively, remote monitor 106 can be implemented to consume more power (e.g., through the addition of physiological monitoring functions), such as in cases in which maintaining very low energy consumption is not a concern (e.g., when a wearer is intended to wear the device for a shorter period of time). For example, the transmission of a small number of bytes (e.g., 4-16 bytes) can be typically be accomplished in less than 500 ms. Accordingly, even if remote monitor 106 is “on” for 0.5 seconds while detecting ultrasonic signals and acquiring information from one or more other sensors, when not actively transmitting remote monitor 106 can consume significantly less energy (e.g., on the order of a few milliamps, such as 5 mA). In a particular example, transmitting 4-16 bytes (at low power) can be completed in 10-100 ms, especially if orthogonal coding is not required to distinguish different remote monitors (e.g., without transmitting a serial number to facilitate identification of a transmitting remote monitor by local monitor 112 and/or central monitoring system 118). In some embodiments, each remote monitor 106 can be configured to transmit using a particular frequency that can be varied from remote monitor to remote monitor such that the transmission frequency can be used to identify which remote monitor sent a particular RF signal. Additionally or alternatively, in some embodiments, each remote monitor 106 can be configured to transmit using a particular time delay after reception of an ultrasonic signal (or other activation event). In some embodiments, when remote monitors are distinguished using transmission frequency and/or time delay, a remote monitor can periodically (at regular and/or irregular intervals) include identifying information with a transmitted signal. For example, such information can be transmitted with every other, every fourth, every tenth, etc., RF signal sent by a remote monitor.

In some embodiments, local monitor 112 can be configured to detect RF signals on a band of frequencies with each remote monitor frequency separated by a reasonable frequency margin, such as a 10 to 100 kilohertz (kHz) margin between frequencies. For example, a local monitor 112 that is wall powered can implement high performance digital filtering/extraction techniques to detect signals across a relatively wide band of frequencies. For example, one of the ISM bands is 902 MHz to 928 MHz, a 26 MHz span. If a 10 MHz subset of this band (e.g. 910-920 MHz) was selected, and there were 100 different remote monitors each separated at 100 kHz intervals (e.g., at 910.0 MHz, 910.1 MHz, 910.2 MHz, etc.), signals transmitted by such remote monitors can be expected to be resolved by local monitor 112 using conventional techniques. In a more particular example, many software-defined radio (SDR) receiver processors can be configured to implement receiver bandwidths to 10 kHz or less (a factor of 10 smaller than described the example described above). Using such techniques transmission time can be limited to about 100 ms, which can reduce the total power consumption by about a factor of five. That is to less than 50 mAh/150 mW for an entire week. In such an implementation, and even smaller power source than described above can be used, which can make recharging (or powering) entirely through energy harvesting techniques more feasible.

In some embodiments, hardware 400 can include memory 432, which can be implemented using any suitable technique or combination of techniques. For example, memory 432 can be implemented as serial memory. In some embodiments, memory 432 can store any suitable information, such as information indicative of a state of accelerometer 406 at various points in time (e.g., when remote monitor 106 awakens, at periodic intervals when remote monitor 106 is in a low power state, etc.). Additionally, in some embodiments, memory 432 can store time stamps information indicating when remote monitor 106 transitioned to a higher power state, when ultrasonic signals were received, etc.

In some embodiments, hardware 400 can include one or more wireless transmitters 424, which can be used to implement at least a portion of communication system 328. In some embodiments, controller 402 and wireless transmitters 424 can be implemented on a common chip or common substrate as indicated by 426. In some embodiments, hardware 400 can include a first antenna 428 and a second antenna 430 that are coupled to wireless transmitter 424. In some embodiments, antenna 428 and antenna 430 can be positioned on different sides of remote monitor 106 to facilitate more robust transmission, in case one of the antennas is covered by a portion of a wearer's body. In some embodiments, wireless transmitter 424 can use both antennas 428 and 430 to transmit every other RF signal. For example, antenna 428 can be used to transmit a first signal, antenna 430 can be used to transmit a second signal, antenna 428 can be used to transmit a third signal, etc. This dual-event transmission can increase the probability of link closure, as the antennas can be oriented differently, which can be important if the wearer is lying on the floor covering one of the antennas with a portion of their body. For example, in a remote monitor with an arm band form factor, the two antennas can be on opposite sides of the arm band and no matter how the wearer is oriented on the floor, at least one of the antennas would be more likely to be pointed away from the floor than if only a single antenna were used. Note that in some embodiments, although not shown, one or more optical emitters (e.g., implemented using one or more light emitting diodes, one or more laser diodes, one or more super luminescent diodes, and/or any other suitable light emitter) can be used in lieu of or in addition to antennas 428 and 430. In such an example, wireless transmitter 424 can be implemented to encode information onto optical signals emitted by the optical emitter(s) by modulating the brightness of the light emitted by the optical emitter(s).

In some embodiments, reception of an ultrasonic signal (and/or any other activation event) can reset an internal timer of remote monitor 106, and in the absence of an ultrasonic signal (and/or other activation event), remote monitor can awake based on the time since the last event exceeding a threshold and transmit an RF signal. Such signals can indicate a lack of ultrasonic trigger (e.g., through a flag in the payload of the signal), and can include one or more other parameters (e.g., pressure, accelerometer values, whether or not the unit is being worn, etc.). Accordingly, based on the timer interval, remote monitor can be configured to send a minimum number of wireless communications each minute, which can be used as an indication that the remote monitor is functioning even if it is not receiving ultrasonic signals. If there is no communication from a given remote monitor (e.g., as determined by the central monitoring system 118) within a predetermined period of time, an automatic alert can be generated, and the last known confirmed communication from a given remote monitor can be known, which can be used to indicate a last known location of the wearer (e.g., based on the location determined based on reception times of ultrasonic signals, based on a proximity detection event, based on which local monitor relayed a signal to central monitoring system 118, etc.). For example, the remote monitor can lose power, be disabled or destroyed, be submerged in water, be isolated within a wireless signal blocking environment (e.g., a radiopaque material such a metal or mesh that blocks RF communications in the case of RF-based communications, a material that blocks light-based signals and electromagnetic radiation requiring line of sight such as millimeter waves, etc.). Additionally, in some embodiments, if a given remote monitor has been transmitting wireless signals in response to ultrasound signals, and subsequently ceases to transmit wireless signals responsive to ultrasound signals, but continues to transmit periodic wireless signals (e.g., as determined by the central monitoring system 118), an automatic alert can be generated, and the last known confirmed communication from a given remote monitor can be known, which can be used to indicate a last known location of the wearer. For example, the wearer may be laying on top of the remote monitor blocking the ultrasound signals, but allowing the wireless signals to reach the local monitor.

In some embodiments, remote monitor can record accelerometer values from accelerometer 406 at a very low rate (e.g., once or twice each second), which can be sufficient to capture posture/gait profiles, as well as indications of stumbling. Such data can be stored in memory 432, which can be available for offload periodically at regular and/or irregular intervals (e.g., once per week, after a fall event, etc.). Such an offload can be performed by coupling remote monitor 106 to a reader device (e.g., using a wired connection, a near field communication connection, etc.). Additionally or alternatively, depending on desired run time and overall power consumption, the data can be periodically offloaded wirelessly (e.g., during a nighttime recharging procedure, such as through a recharging coil placed under the wearers mattress pad).

FIG. 4B shows an example 450 of the placement of components that can be used to implement remote monitor 106 of FIG. 1 in a particular form factor in accordance with some embodiments of the disclosed subject matter. As shown in FIG. 4B, hardware 400 can be implemented in a relatively small form factor.

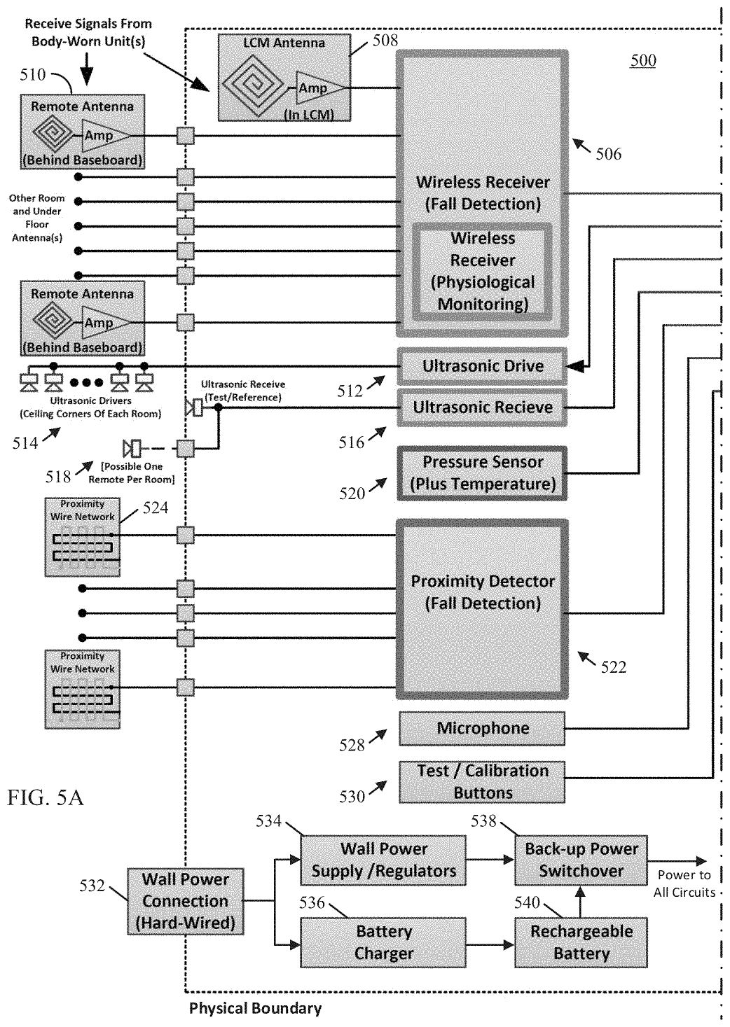

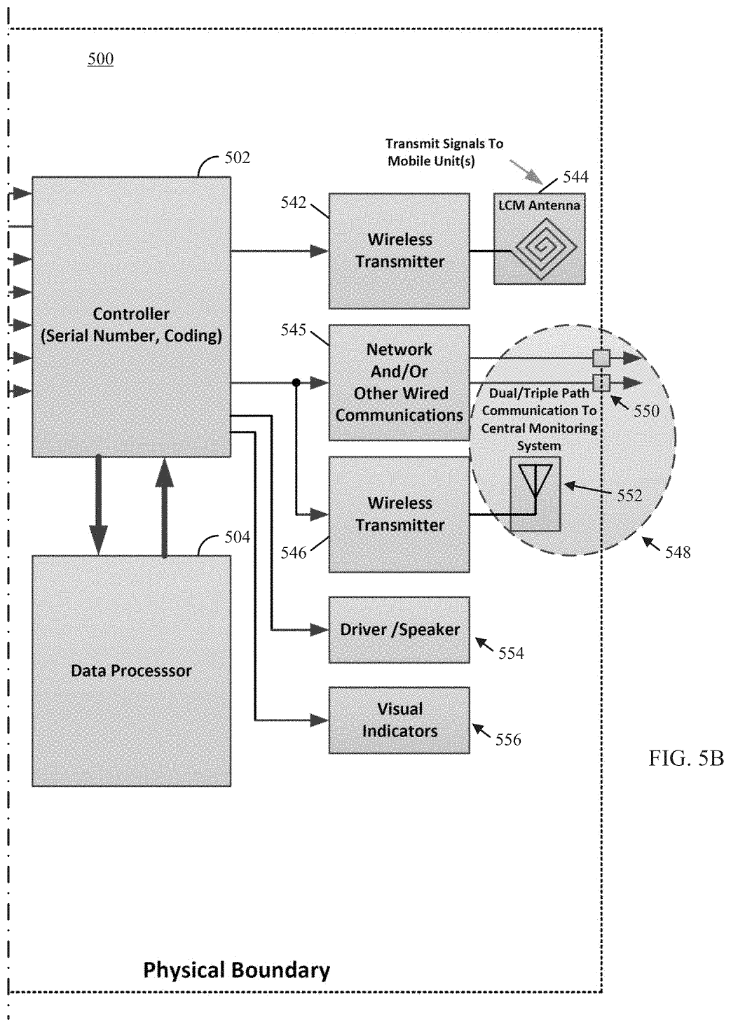

FIGS. 5A and 5B show an example 500 of hardware components that can be used to implement a portion of local monitor 112 of FIG. 1 in accordance with some embodiments of the disclosed subject matter. As shown in FIGS. 5A and 5B, hardware 500 can include a controller 502 and a data processor 504 (e.g., implemented using a microcontroller, a microprocessor, an FPGA, an ASIC, a GPU, etc.). For example, local monitor 112 can be implemented with a dedicated processor (e.g., a microcontroller, microprocessor, FPGA, etc.). Specific and field-programmable gate array (FPGA)-based approaches can be used to allow for upgrades and changes. In some embodiments, controller 502 and data processor 504 can be implemented using a single chip.

In some embodiments, hardware 500 can include a wireless receiver 506 that is coupled to controller 502 an internal antenna 508 and one or more remote antennas 510. In some embodiments, wireless receiver 506 can be configured to detect RF signals transmitted by one or more remote monitors. In some embodiments, wireless receiver 506 can be implemented as a multichannel (e.g., an eight channel) wireless receiver to accommodate an antenna in the body of local monitor 112, as well as multiple remote antennas with integral amplifiers (e.g., placed behind the building baseboards). In a more particular example, multiple remote baseboard antennas (e.g., four antennas in each room, each hidden behind a baseboard on a particular wall) can be located on the four walls of a four-sided room. In such a configuration, remote monitor 106 would likely have a relatively clear communication path to at least two of the wall antennas no matter how the wearer's body is orientated. Additionally, in some embodiments, a “long wire” antenna (e.g., on the length order of the radio AM band) can be placed under the flooring to provide an antenna that can receive a signal from an antenna of a remote monitor 106 that is facing the floor, which can provide nearly optimum coupling and excellent wireless link closure between the remote antenna and remote monitor 106. In some embodiments, wireless receiver 506 can be implemented as a software defined radio (SDR), which can allow flexibility for the future, such as adding a wireless sub-block that can be dedicated to physiological monitors of various types (e.g., to keep wireless communication paths used by remote monitors 106 dedicated and relatively interference free). Note that in some embodiments, although not shown, one or more optical detectors (e.g., implemented using one or more photodetectors) can be used in lieu of or in addition to internal antenna 508 and/or remote antennas 510. In such an example, wireless receiver 506 can be implemented to detect and/or demodulate information encoded in signals detected by the optical detector(s).

In some embodiments, hardware 500 can include an ultrasonic driver 512 that is coupled to controller 502 and various ultrasonic transducers 514, and an ultrasonic receiver 516 that is coupled to controller 502 and one or more ultrasonic transducers 518. In some embodiments, controller 502 can cause ultrasonic driver 512 to cause ultrasonic transducers to emit ultrasonic signals at particular times. Additionally, in some embodiments, controller 502 can receive signals from ultrasonic receiver 516 to verify that ultrasonic transducers 514 are operating as expected (e.g., by detecting an ultrasonic signal a predetermined time after emission of the signal from a particular ultrasonic transducer). For example, local monitor 112 can include ultrasonic drive circuits 512 and can operate four ultrasonic transducers 514 in the upper ceiling corners for each sub-unit room. In a more particular example, a three-room suite can include a total of twelve ultrasonic transducers 514. As another example, an ultrasonic transducer/microphone 518 can included in local monitor 112 to be used for testing and/or verification and/or a remote transducer/microphone 518 can be installed in each room and coupled to local monitor 112.

In some embodiments, hardware 500 can include a pressure and/or temperature sensor 520 coupled to controller 502, which can be used to measure ambient conditions in the space being monitored. For example, pressure sensor 520 can detect barometric pressure at the location of local monitor 112, and use the value to determine whether a pressure value received from a remote monitor 106 is indicative of remote monitor 106 being located near the floor of the space. For example, pressure sensor 520 can be used as the above/below reference to determine if the pressure value received from a remote monitor 106 is in an “above” (not on the floor) or “below” (on the floor) condition.

In some embodiments, hardware 500 can include a proximity detector 522 coupled to controller 502 and one or more proximity wires 524 which can be located near the floor of the space, and/or near doors, windows, etc. In some embodiments, hardware 500 can include a microphone 528 and one or more inputs 530 (e.g., inputs 306) coupled to controller 502 that can be used to provide input to local monitor 112. For example, proximity detector 522 can include circuitry that drives and/or receives proximity signals obtained from the under-the-floor (e.g., under-the-carpet) wiring 524. In a particular example, proximity wires 524 can be implemented as a meandering long wire (or pair of wires, for redundancy) for each room. In such an example, each room in a multi-room unit can be equipped with at least one pair of wires. In some embodiments, when a proximity coil in a remote monitor (e.g., proximity coil 412) comes into range of proximity wires 524, hardware 500 can generate a signal that is indicative of the presence of the remote monitor, and can send the signal to a central monitoring system (e.g., central monitoring system 118). Additionally or alternatively, in some embodiments, when the proximity coil in the remote monitor (e.g., proximity coil 412) comes into range of proximity wires 524, the remote monitor can generate a signal that is indicative of the presence of one or more particular proximity wires 524, and can send the signal to a central monitoring system (e.g., central monitoring system 118). In some embodiments, multiple systems can be used to decrease the likelihood of false positives and/or false negatives. For example, if two systems (e.g., an ultrasound propagation time-based system and a proximity coil-based system) provide conflicting information (e.g., one indicating that a wearer has likely fallen down, and the other indicating that wearer has not fallen down) hardware 500 can generate an alert to indicate that an anomaly has occurred. Such anomalies may arise, for example, if two remote monitors appeared to have the same identifying information (e.g., due to an error, or due to a malicious user attempting to clone a remote monitor), the two monitors may provide conflicting data.

In some embodiments, hardware 500 can include a connection 532 to wall power (e.g., a wire, a plug, a receptacle, etc.), which can be coupled to a power regulator 534 and/or a battery charger 536. In some embodiments, battery charger 536 can be coupled to a battery 540, and can be configured to keep battery 540 charged (e.g., to a desired state of charge) while power is being supplied through wall power connection 532. In some embodiments, power regulator 534 and battery 540 can be coupled to one or more other components of hardware 500 via a switch 538 that is configured to engage battery 540 in the event that wall power is interrupted.

In some embodiments, hardware 500 can include a wireless transmitter 542 coupled to controller 502 and one or more antennas 544 that can be used to transmit information to one or more remote monitors in the vicinity of local monitor 112 using any suitable technique or combination of techniques (e.g., 900 MHz communications, Bluetooth communications, etc.). Note that, in some embodiments, remote monitors 106 can be implemented as transmission-only devices that are incapable of receiving wireless communications from local monitor 112. In some embodiments, wireless transmitter 542 and/or antenna 544 can be used to implement a short range communication protocol (e.g., to implement NFC communications) such that data can only be communicated to some remote monitors 106 when brought into close proximity to local monitor 112. Such communications can be used, for example, to offload data from remote monitor 106, to provide software and/or firmware updates to remote monitor 106, to provide data to remote monitor 106 (e.g., identifying information, a transmission frequency, a transmission delay, etc.), etc. In some embodiments, other remote monitors (e.g., physiological monitors) can also communicate with local monitor 112, and can be configured to receive communication from local monitor 112.

In some embodiments, hardware 500 can include network and/or other wired communication hardware 545 and a wireless transmitter 546 coupled to controller 502, which can be used to one or more wired and/or wireless connections 548 to central processing system 118 using any suitable technique or combination of techniques, such as through an Ethernet network, a powerline network, a telephone network, a coaxial network, a Wi-Fi network, a cellular network, etc. For example, hardware 500 can include one or more wired connections 550 (e.g., one or more ports, one or more plugs, one or more terminals, etc.) and/or one or more antennas 552.

In some embodiments, hardware 500 can include a speaker 554 and/or one or more visual indicators 556 (e.g., used to implement display 304) coupled to controller 502 that can be configured to emit audio and/or visual signals.

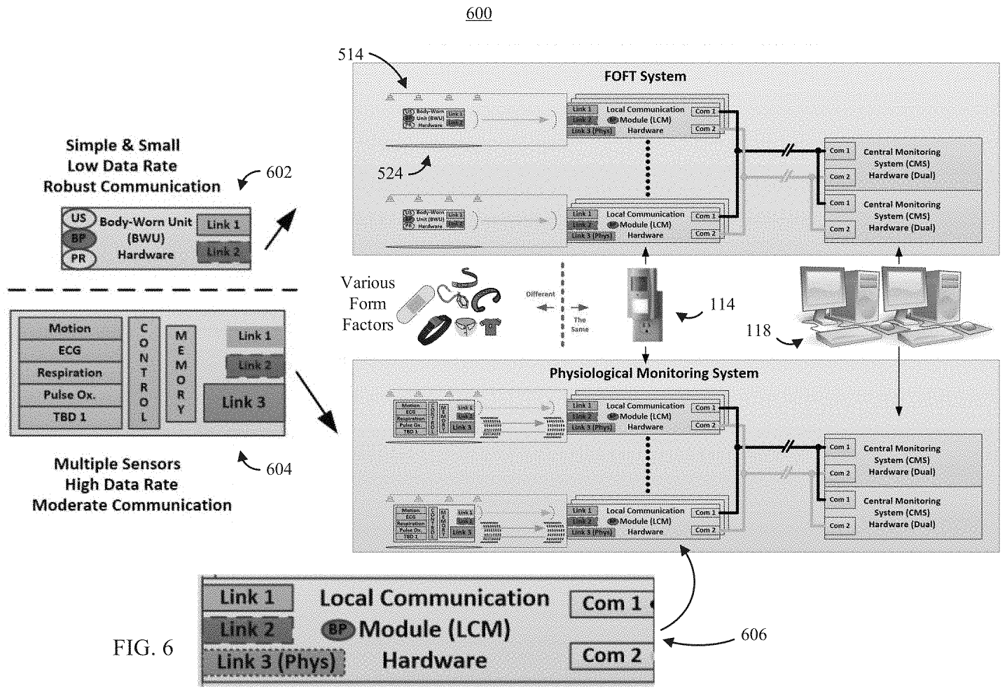

FIG. 6 shows an example 600 of a system that can be used to determine the location of a remote monitor associated with a subject and to receive physiological data of the subject using a remote physiology monitor in accordance with some embodiments of the disclosed subject matter. As shown in FIG. 6, a local monitor 112 and/or central monitoring system 118 can be used to support multiple types of remote monitors, such as a body-worn unit (BWU) 602 (e.g., which can be implemented as a remote monitor 106) and a physiological monitor 604. Accordingly, although shown as separate systems, a fallen on the floor (FOFT) detection system and a physiological monitoring system can share common infrastructure (e.g., local monitor 112 and central monitoring system 118). In some embodiments, a local communication module (LCM) 606 (e.g., which can be implemented as a local monitor 112) can be located in various locations around a facility or other space such that it can receive communications from BWU 602 and/or physiological monitors 604. In the example shown in FIG. 6, LCM 606 can control ultrasound transducers 514 and can detect time delays for each BWU unit 602 and each transducer 514 based on communications from BWU 602 to LCM 606, with the LCM 606 and/or central monitoring system 118 determining the location of each BWU 602 and/or determining if a wearer of a BWU has fallen.

In some embodiments, central monitoring system 118 can be a dual computer configuration with battery backup and redundant communication links to each LCM 606. Each LCM 606 can communicate wirelessly with central monitoring system 118 (e.g., using one or more RF protocols), with different LCMs 606 communication using different frequency bands, time-division multiplexing, code-division multiplexing, etc., to achieve two-way communication with central monitoring system 118. Additionally or alternatively, in some embodiments, each LCM 606 can communicate with central monitoring system 118 using a power line network to which both LCM 606 and central monitoring system 118 are connected (e.g., using time-division multiplexing, code-division multiplexing, etc.) with identification numbers (e.g., an address) for each LCMs 606 and/or central monitoring system 118.

In some embodiments, the operating system and software environment used to implement central monitoring system 118 can include various independent but intercommunicating modules, which can be enhanced or upgraded from time to time, and which can function in real time (i.e., against “clock ticks”), and which can be relatively easily installed in each facility. In some embodiments, central monitoring system 118 can use a Linux operating system, running a “containerization” package which in turn can manage individual application modules, allowing for selective independent software module upgrades and electronic (e.g., remote via the Internet) installation and maintenance across many facilities, from a central location (e.g., a server, a data center, a backend, etc.).

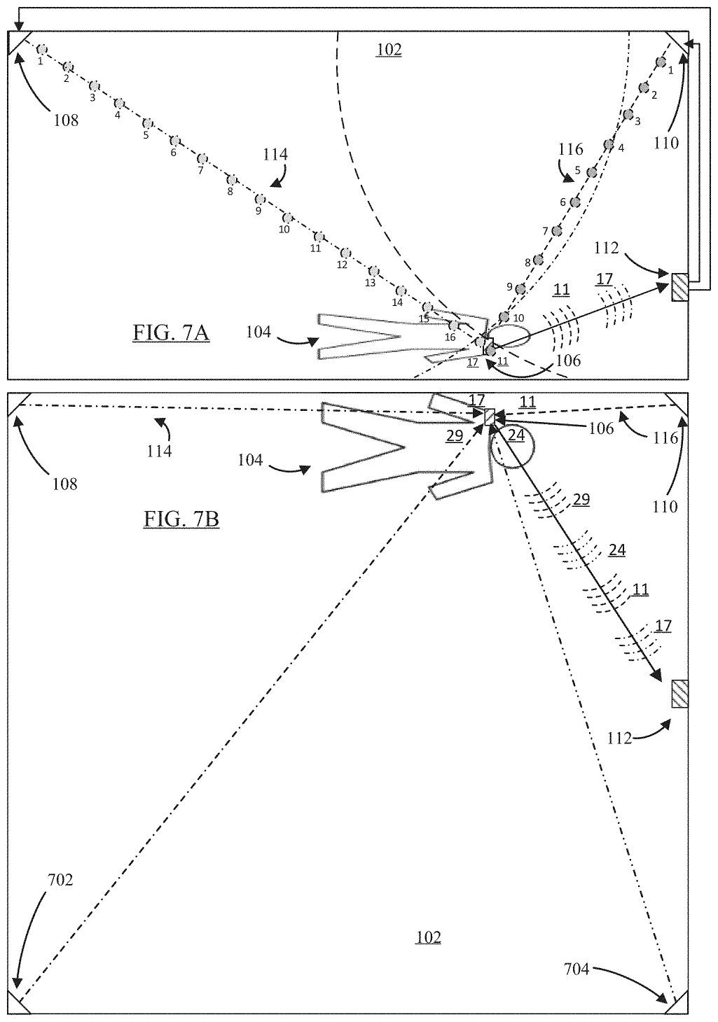

FIGS. 7A and 7B show cross-sectional and top-down views of a room in which a system for determining three dimensional location of an object associated with a person at risk of falling down has been implemented in accordance with some embodiments of the disclosed subject matter. As shown in FIGS. 7A and 7B, the propagation time of various ultrasonic signals can be determined by local monitor 112 by determining the time from emission of the signal to detection of an RF signal transmitted by remote monitor 106. As shown in FIG. 7B, four propagation delays can be generated based on signals from four ultrasonic transducers 108, 110, 702, 704 can be determined, and based on the distances corresponding to the delay and the locations of ultrasonic transducers 108, 110, 702, 704, local monitor 112 and/or central monitoring system 118 can calculate a position of remote monitor 106 within room 102. In the example shown in FIGS. 7A and 7B, person 104 wearing remote monitor 106 is on the floor, which can be determined based on the calculated location.

FIG. 8 shows an example 800 of a process for determining three dimensional location of an object associated with a person at risk of falling down in accordance with some embodiments of the disclosed subject matter. As shown in FIG. 8, at 802, process 800 can wait a predetermined amount of time (e.g., 10 seconds, 15 seconds, 20 seconds, 30 seconds, etc.) from a last transmission (note that a first transmission can occur at any suitable time).

At 804, process 800 can cause a first ultrasound transducer to emit an ultrasound signal. As described above, the ultrasound signal can be a pulse or a particular length, and may or may not be encoded with data. For example, process 800 can cause ultrasound transducer 108 to emit an ultrasound signal.

At 806, process 800 can receive a signal (or signals) from one or more remote monitors (e.g., remote monitors 106) that indicates a time at which the first ultrasound signal was received at the remote monitor. The signal received at 806 may or may not include data (e.g., barometric pressure, accelerometer data, temperature, on-body verification signal, etc.). Note that the signals are likely to be received from different remote monitors at different times, as different people are likely to be different distances from a particular ultrasound transducer. As described above, in some embodiments, the received signal can include identifying information that can be used to identify which remote monitor transmitted the signal. Additionally or alternatively, in some embodiments, each signal can be received at a different carrier frequency (e.g., 901.1 MHz, 902.5 MHz, etc.) and/or after a different time delay that is particular to the remote monitor. In some embodiments, the length of the time delay can be encoded in the signal, which can be used as identifying information.

At 808, process 800 can record the time between transmission of the ultrasound signal and reception of the ultrasound signal by each remote monitor based on the time at which the wireless signal was received from the remote monitor.

At 810, process 800 can determine whether an ultrasound signal is to be emitted using another ultrasound transducer. If process 800 determines that there is another ultrasound transducer (“YES” at 810), process 800 can move to 812 and can cause the next ultrasound transducer (e.g., ultrasound transducer 110) to emit an ultrasound signal, and process 800 can return to 806.

Otherwise, if process 800 determines that there is not another ultrasound transducer (“NO” at 810), process 800 can proceed to 814. For example, if process 800 has caused each ultrasound transducer 108, 110, 702, and 704 in room 102 to emit an ultrasound signal, process 800 can determine that there is not another ultrasound transducer.

At 814, process 800 can determine a 3D location within the space being monitored of one or more remote monitors based on the ultrasound signal propagation times recorded at 808. In some embodiments, 814 can be omitted (e.g., where local monitor 112 does not determine a location of the remote monitors) and/or performed by a device that did not calculate the propagation times (e.g., central monitoring system 118).

At 816, process 800 can communicate propagation times, 3D location, and/or other information about a wearer of each remote monitor to a central monitoring device. For example, process 800 can cause the information to be sent via PLC over a power line network, via Wi-Fi, via a direct RF connection, etc.

In some embodiments, process 800 can control emission of ultrasound signals in a particular space (e.g., a room, such as room 102 described above in connection FIGS. 1, 7A, and 7B). In some embodiments, a single device (e.g., a single local monitor 112) can control ultrasound transducers in different spaces by executing process 800 at staggered times for each room. For example, as all ultrasound signals can be emitted in a short time (e.g., within 100 to 500 ms), ultrasound transducers in a first space can be operated during a first time, and a short time later (e.g., 2-10 seconds later), process 800 can be used to operate ultrasound transducers in another space. In such an example, because ultrasound is generally limited by line of sight, a device executing process 800 can associate RF signals with a particular space. For example, when the ultrasound transducers in the first space are being operated, process 800 can determine that each RF signal is from a remote monitor in that space, as the ultrasound signal is unlikely to reach a remote monitor in a different space. In some embodiments, multiple local monitors executing process 800 can similarly distinguish remote monitors in a particular space being monitored from other remote monitors (from which an RF signal may be received, as RF signals can often penetrate through walls and other obstructions) by ignoring RF signals received outside of the time during which ultrasound transducers are actively being controlled (e.g., from 804 to 812). In some embodiments, in response to receiving propagation times associated with one or more remote monitors, the central monitoring device can calculate a 3D location of the remote monitor(s). For example, if the 3D location was not calculated at 814 (e.g., if 814 was omitted), the central monitoring system (e.g., central monitoring system 118) can perform 814 based on information communicated at 816, rather than 814 being performed by a local monitor that received the wireless signals at 806.

At 818, process 800 can determine whether a particular remote monitor is near the floor of the space within which that remote monitor is located based on a 3D location determined at 814 and/or based on a 3D location determined by the central monitoring system. In some embodiments, a remote monitor can be determined to be near the floor if the 3D location of the remote monitor within a threshold distance of the floor. For example, process 800 can determine that a particular remote monitor is near the floor of the space if the remote monitor is within 0.3 meters (about 1 foot) of the floor. As another example, process 800 can determine that a particular remote monitor is near the floor of the space if the remote monitor is within 0.6 meters (about 2 feet) of the floor. Note that these are merely examples, and a distance that is near the floor can be any suitable distance, which may vary from individual to individual. In some embodiments, process 800 can compare the distance to the floor to a threshold distance that is associated with a particular remote monitor (e.g., each remote monitor can have an individualized threshold). In some embodiments, process 800 can determine a distance to the floor using any suitable technique or combination of techniques. For example, process 800 can plot the 3D location of the remote monitor within a model of the space within which the remote monitor is located, and can determine whether the 3D location falls within a regions designated as near the floor (e.g., represented by a volume that extends the threshold distance from the floor at every point in the space). As another example, process 800 can plot a vector from the determined 3D location that intersects a portion of a plane representing the floor beneath the 3D location, and determine the length of the vector to determine the distance to the floor.

If process 800 determines that a particular remote monitor is not near the floor (“NO” at 818), process 800 can return to 802 to wait until a predetermined time has passed since information was communicated at 816 and/or since a last ultrasound emission occurred at 812. Otherwise, if process 800 determines that a particular remote monitor is near the floor (“YES” at 818), process 800 can proceed to 820.

At 820, process 800 can cause an alert to be provided to a caregiver and/or emergency services indicating that a wearer of the remote monitor may have fallen on the floor. In some embodiments, the alert can include any suitable information, such as the location of the wearer (e.g., based on the location determined based on reception times of ultrasonic signals, based on a proximity detection event, based on which local monitor relayed a signal to central monitoring system 118, etc.), and physiological signals (e.g., as described above in connection with FIG. 6). In some embodiments, process 800 can cause the alert to be provided using any suitable technique or combination of techniques. For example, the central monitoring system (e.g., central monitoring system 118) can cause an audio and/or visual alert to be provided via a computing device (e.g., a smartphone, a tablet, a laptop computer, a personal computer, a terminal, etc.) or a communication device (e.g., a pager, a cellular phone) associated with a caregiver (e.g., a medical practitioner such as a nurse or a doctor, a family member, etc.). In such an example, the central monitoring system can cause the alert to be provided via an indirect connection (e.g., a push notification system that receives messages at a server and directs the messages via an application installed on the computing device), or via a direct connection (e.g., a peer to peer connection between the central monitoring system and the computing device or communication device, such as via a cellular connection, a local network via a wire and/or wireless network, etc.). As another example, the central monitoring system (e.g., central monitoring system 118) can directly present an alert via an audio and/or visual alert using hardware associated with central monitoring system 118 (e.g., via a display, via speakers, via an indicator lamp, etc.). As yet another example, in some embodiments, process 800 can contact emergency services (e.g., directly via telephone, via a service that relays information provided from the central monitoring system to emergency services via a human that is presented with information to provide to emergency services) to relay the alert and/or information about the wearer, such as the location of the wearer, identifying information of the wearer, information associated with the wearer (e.g., age, heath conditions, etc.), an indication that the wearer may have fallen down, etc.

In some embodiments, process 800 can provide an alert and/or contact emergency services if the remote monitor has been near the floor for a predetermined amount of time and/or if another condition is satisfied. For example, if process 800 determines at 818 that the remote monitor is near the floor, process 800 can wait until the remote monitor is confirmed to be near the floor again at 818 after returning to 802 before moving to 820 and generating the alert (e.g., the remote monitor be required to be near the floor for at least 10 seconds, 15 seconds, etc., before generating an alert). Additionally or alternatively, as described above in connection with FIGS. 4A and 5, other information can be used to determine if a wearer of a remote monitor may be in distress, and process 800 can cause an alert to be provided at 820 based on any suitable combination of indicators (e.g., based on the reading of a pressure sensor, based on whether wireless communications from the remote monitor have stopped, based on an indication that the remote monitor has been removed, based on a signal from one or more proximity detectors, etc.).

FIG. 9 shows an example 900 of a process for receiving and relaying signals that can be used to determine a three dimensional location of an object in accordance with some embodiments of the disclosed subject matter. As shown in FIG. 9, at 902, process 900 can wait for reception of an ultrasound signal (or other activation action, such as a help button press or proximity detection) while a device executing process 900 is in a low power state.

At 904, process 900 can determine whether an ultrasound signal has been detected via an ultrasound detector (ultrasound detector 404). If process 900 determines that an ultrasound signal has not been detected (“NO” at 904), process 900 can move to 906, and can determine whether a maximum time (e.g., 20 seconds, 21 seconds, 25 seconds, 30 seconds, or any other time period that is longer than the time period between ultrasound emissions) has elapsed since the low power state was entered. If process 900 determines at 906 that the maximum time has not elapsed (“NO” at 906), process 900 can return to 902 to continue waiting for the ultrasound signal (or other activation signal).

Otherwise, if process 900 determines at 904 that an ultrasound signal (or other activations signal) has been received (“YES” at 904), or if process 900 determines at 906 that the maximum time has elapsed (“YES” at 906), process 900 can proceed to 908.

At 908, process 900 can wake the device executing process 900 from the low power state, and can send data for reception by a local monitor (e.g., local monitor 112). As described above, the data can be the presence of the signal itself, the duration of the signal (e.g., matching a duration of the ultrasound signal), identifying information of the device executing process 900, additional information such as an on-body signal, a pressure value, an accelerometer value, etc., any other suitable data, or any suitable combination thereof. In some embodiments, additional information can be sent only upon waking, with every transmission, or with every transmission that is not the result of an initial ultrasound detection (e.g., with any transmission other than a transmission indicating detection of an ultrasound signal in the low power state).

At 910, process 900 can wait for another ultrasound signal for a predetermined amount of time (e.g., up to 100 ms, 200 ms, 250 ms, 500 ms, 1 s, etc.). At 912, process 900 can determine if another ultrasound signal has been received within the predetermined time. If process 900 determines at 912 that an ultrasound signal has been detected (“YES” at 912), process 900 can send data for reception by a local monitor at 914. Note that the signal that is transmitted at 908 and/or 914 can be a signal that is not addressed to any particular device, as the device executing process 900 is unlikely to have access to information identifying a local monitor that is intended to receive the data. That is, the signal emitted at 908 and/or 914 can be broadcast such that it can potentially be received by any device that is configured to detect signals at the appropriate frequency. In some embodiments, data (such as personally identifiable information (PII) or protected health information (PHI)) sent at 914 can be encrypted or otherwise protected using any suitable technique or combination of techniques. For example, each remote monitor (e.g., remote monitor 106) can be associated with a public key and private key pair, and the central monitoring system (e.g., central monitoring system 118) and/or local monitor (e.g., local monitor 112) can store the private key associated with each remote monitor associated with a particular system. In such an example, the remote monitor can encrypt a signal using its public key, and the local monitor or central monitoring system can decode the signal using the corresponding private key.

Additionally or alternatively, in some embodiments, it may be desirable to perform a decryption operation at any point in the system. For example, the remote monitor 106 can encrypt any or all information before transmitting the information, and encrypted information can be conveyed in an encrypted state until it is decrypted by the central monitoring system. As another example, the remote monitor 106 can encrypt any or all information before transmitting the information, and encrypted information can be conveyed in an encrypted state until it is decrypted by a local monitor. In such an example, the local monitor can decrypt information received from a remote monitor (e.g., to analyze the information and determine whether the remote monitor is near the floor, being worn, etc.), and can transmit the original information received from the remote monitor and/or information resulting from analysis performed by the local monitor. The original information received from the remote monitor can be in the originally encrypted form (e.g., the local monitor can decrypt one copy of the information, and transmit a second copy without decrypting the information), encrypted using a different technique (e.g., encryption associated with a wireless network and/or wireless connection used to transmit information from the local monitor to the central monitoring system) and/or a different key (e.g., a key associated with the local monitor), or in the clear (e.g., without any encryption, for example, if the information is being transmitted over a wired network).

As yet another example, in some embodiments, ultrasound transducers (e.g., ultrasound transducers 514) can be configured to decrypt a signal received from the local monitor and/or other ultrasonic transducers. For example, one or more transducers can be associated with hardware and/or software that can be used to decrypt signals received from remote monitors and/or other ultrasonic transducers, and such information can relayed to a local monitor associated with the transducer, to the central monitoring system, and/or to any other suitable destination.

Otherwise, if process 900 determines at 912 that an ultrasound signal has not been detected within the predetermined time (“NO” at 912), process 900 can move to 916 and can cause the device executing process 900 to enter the low power state. Additionally, at 916 (or alternatively upon receipt of the last ultrasound signal at 904 or 912) process 900 can begin a timer to determine whether a maximum time between ultrasound signal detections has elapsed.

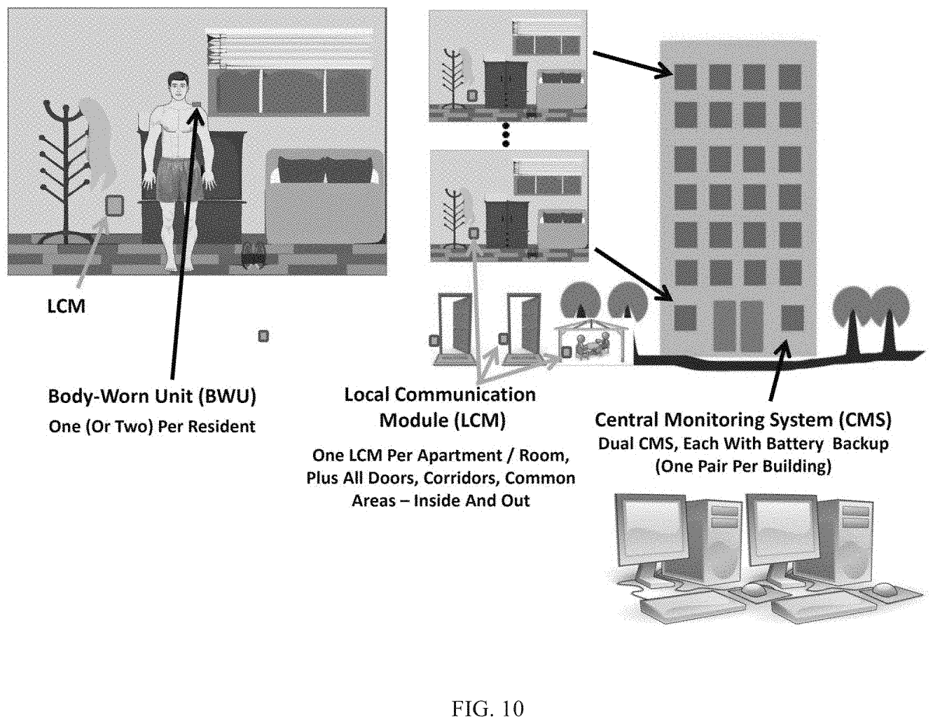

FIG. 10 shows an example of a facility equipped with a system for determining three dimensional location of objects in and around the facility implemented in accordance with some embodiments of the disclosed subject matter. As shown in FIG. 10, LCMs (e.g., implemented using local monitors 112) can be installed at various points in and around a facility associated with a group of people that are at elevated risk of falling and being injured. For example, LCMs can be installed around an elder care facility, such as an assisted living facility, a nursing home, the home of a person at elevated risk of falling, etc.

In some embodiments, each resident of the facility can be associated with at least one BWU (e.g., implemented using remote monitors 106) that is configured to detect ultrasound signals, and transmit RF signals indicating that the ultrasound signal has been received by the BWU. In some embodiments, a central monitoring system can be installed locally at the facility, and can be configured to have a battery backup in case of power interruptions. Note that in some embodiments, one or more portions of the central monitoring system can be located off-site. For example, one or more portions of the central monitoring system can be implemented using a physical and/or virtual server located off-site. In such an example, LCMs can communicate directly with the off-site portion of the central monitoring system (e.g., through the internet, through a VPN connection, etc.). Alternatively, in some embodiments, a portion of a central monitor can be installed at the facility that facilitates communication from (and/or to) LCMs to the off-site portion of the central monitoring system.

FIG. 11 shows examples of remote monitors with different form factors that can be used in connection with a system for determining three dimensional location of objects in accordance with some embodiments of the disclosed subject matter. In some embodiments, remote monitor 106 can be implemented as a body-worn unit that includes sensors that can be used to implement the mechanisms described herein, such as an ultrasonic microphone and/or ultrasonic transducer that receives signals from the ultrasonic transmitters driven by a local monitor, and wireless transmitting electronics. The local monitor can be implemented as local communication hardware, which can be relatively simple, small, and low power, such that it will have a minimal impact to end-user residents. The local monitor can be configured as a “wall wart”-type device, as shown in FIG. 11. It can include a wireless receiver that detects wireless signals from the remote monitor (and, in some cases, can perform some local data processing to determine a location of the remote monitor and/or other information), and communication circuits that can relay information to the central monitoring system. As shown in FIG. 11, in some embodiments, dual wireless paths can be used to communicate between the local monitor and the central monitoring system, which can increase the reliability of the entire system. As shown in FIG. 11, the local monitor can be coupled to multiple ultrasonic transducers and under-floor proximity wiring. In some embodiments, the local monitor can be wall-powered with a battery backup, which can increase the reliability, performance and/or robustness of the local monitoring system. In some embodiments, the central monitoring system can be implemented using commercial computer hardware, and can have specialty medical-grade monitoring and alert software. The central monitoring system can also be wall-powered which can insure that the central monitoring system has enough power to perform any processing necessary, but can also incorporate battery backup.

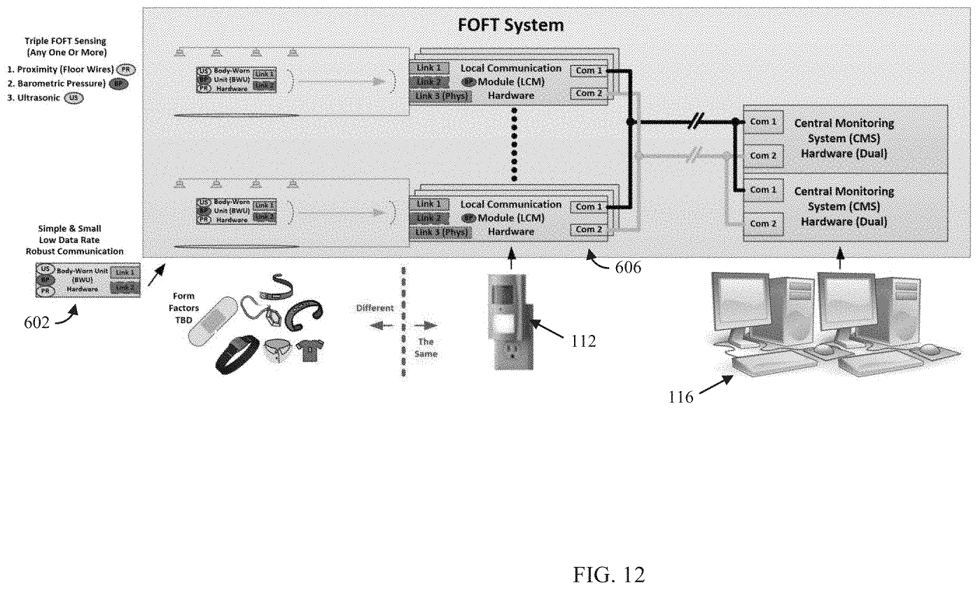

FIG. 12 shows an example of a facility having multiple rooms each equipped with a portion of a system for determining three dimensional location of objects in and around the facility implemented in accordance with some embodiments of the disclosed subject matter. As shown in FIG. 12, two different rooms can each be associated with a dedicated LCM, and each LCM can be connected to the central monitoring system. Although only one BWU is shown in each room, a room can contain zero or multiple BWUs at a given time. As shown in FIG. 12, the BWU can be implemented in many different form factors, and different people can potential wear BWUs with different form factors. For example, a person that has impaired memory function can be outfitted with an adhesive BWU (e.g., implemented as an adhesive bandage) that is relatively difficult to remove, while another person can wear a BWU as a pendant. In some embodiments, each BWU can include and/or utilize any of the fall(en) detection sensing approaches described herein, such techniques based on ultrasonic propagation time, barometric pressure, proximity detection, accelerometer data, etc., or any suitable combination of approaches.

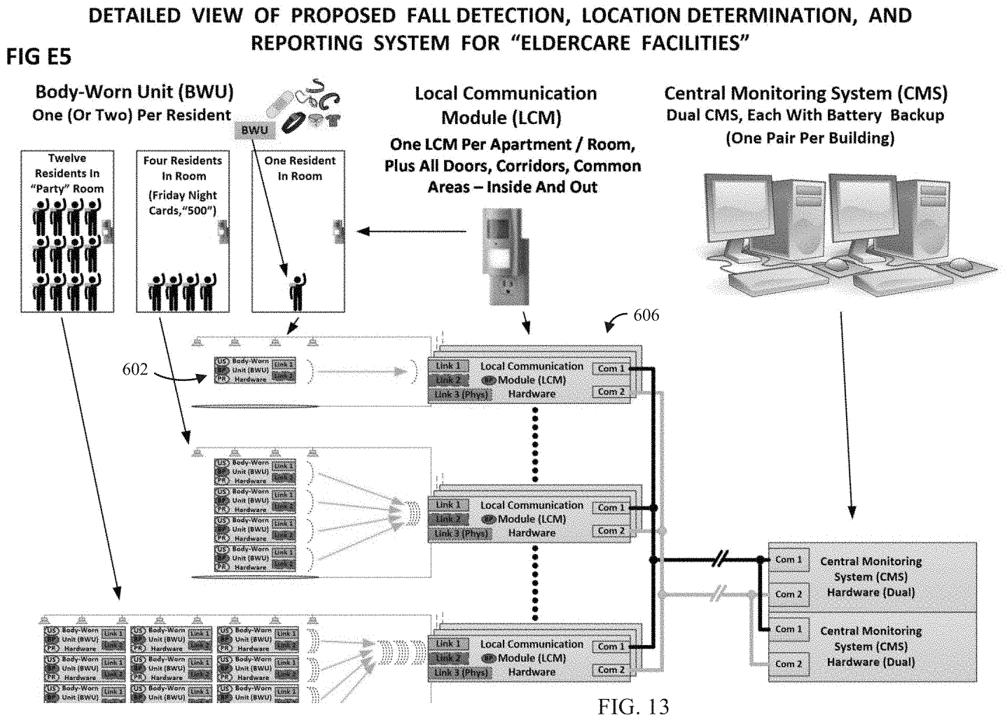

FIG. 13 shows an example of a facility having multiple rooms with variable numbers of objects to be located with each room equipped with a portion of a system for determining three dimensional location of objects in and around the facility implemented in accordance with some embodiments of the disclosed subject matter. As shown in FIG. 13, relatively large numbers of BWUs can be present in a space being monitored, and variable numbers of BWUs can be present in various spaces being monitored. Note that all of the BWUs in a given space are likely to be activated by the same ultrasound signal, accordingly there is a greater likelihood that multiple BWUs may simultaneous send a wireless signal indicating reception of a particular ultrasound signal. Mitigation of this communications overlap can be addressed using various techniques, such as orthogonal coding from each BWU (e.g., based on identifying information associated with the BWU and/or wearer that is included with each wireless signal), frequency diversity (e.g., all BWUs in a particular facility can be configured to have different communication frequencies, which can be based on and/or used as identifying information associated with the BWU and/or wearer), having random time delays from each BWU, or other potential techniques. In some embodiments, a duration of the wireless signal can be based on the duration of the ultrasound signal that activated the BWU. For example, the wireless signal can have a duration equal to the duration of the ultrasound signal plus a time delay associated with the BWU. In some such embodiments, the transmission delay time for each BWU may vary if it is affected by a parameter that changes over time. For example, if the voltage output by a battery of the BWU changes, it may affect the clock of the BWU, which can in turn cause the actual transmission delay to change over time. In some embodiments, this can be accounted for using various techniques, such as associating each BWU with a range of delays around an assigned delay, and/or by dynamically estimating changes in the delay (e.g., based on information about the state of the BWU power source, which can be conveyed explicitly or inferred from other information such as a signal strength of the wireless signal).

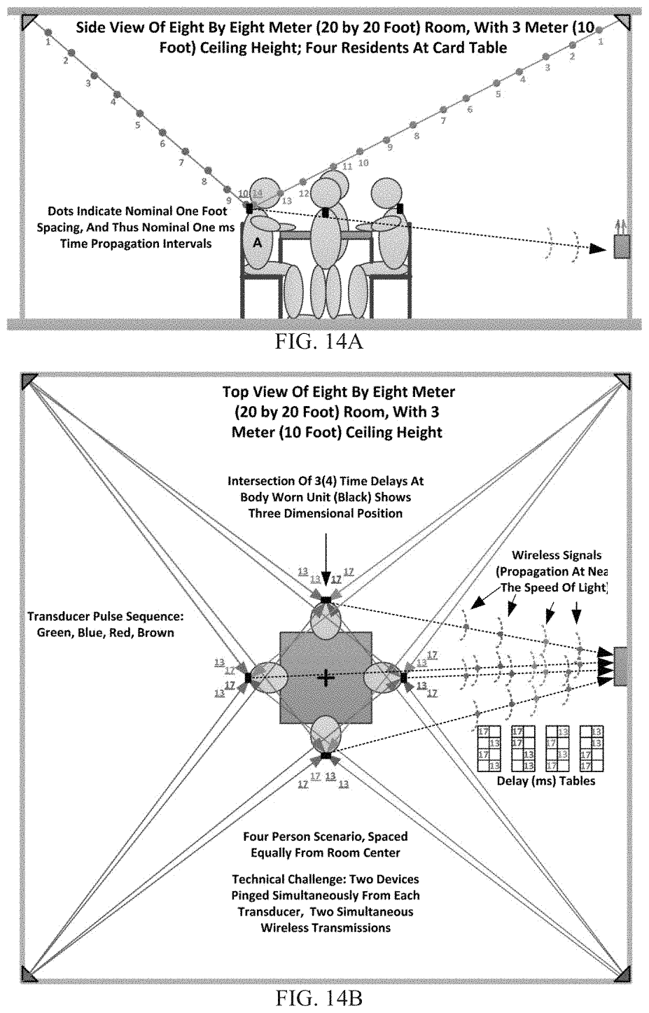

FIGS. 14A and 14B show a cross-sectional and top-down view of a room in which multiple remote monitors are located equidistant from multiple ultrasound transducers. As shown in FIGS. 14A and 14B, a situation may exist in which multiple signals overlap multiple times with relatively few (e.g., four) people in a room that happen to be located equidistant from multiple transducers. In the example shown in FIGS. 14A and 14B, four remote monitors are worn by four people seated around a table that is in the center of the room. Each ultrasonic excitation from any of the transducers would result in two different pairs of wireless signal overlap. Ambiguity that might otherwise be cause by such overlap can be mitigated by using one or more strategies to mitigate signal overlap described above.

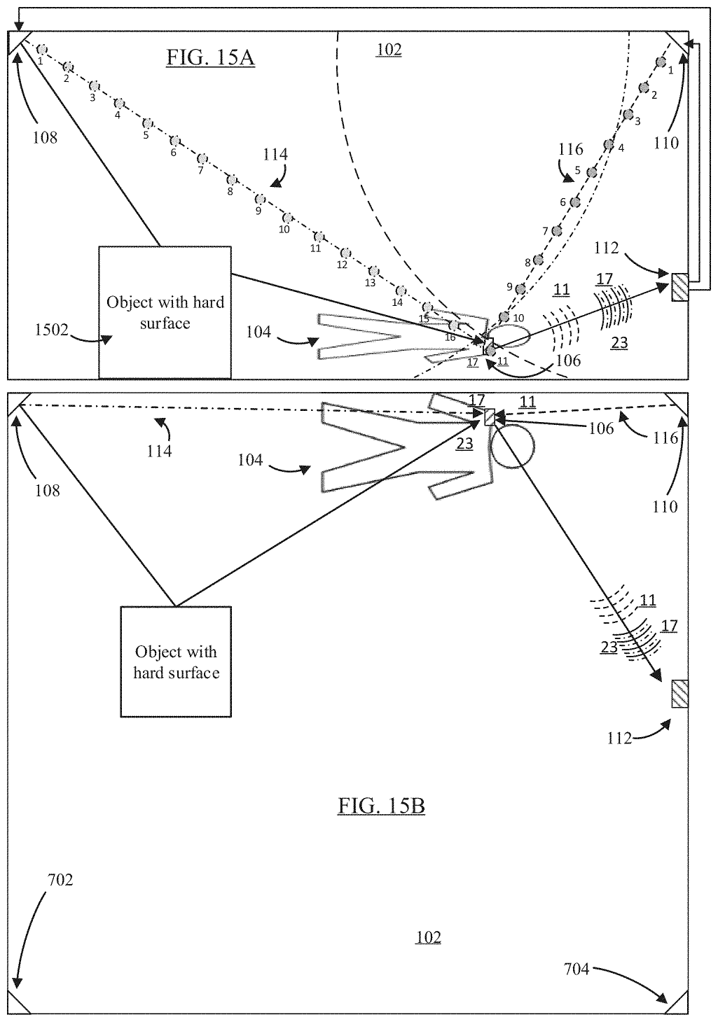

FIGS. 15A and 15B show views of a room that includes an object that reflects an ultrasound signal creating the potential to cause errors in a location determination by a system for determining three dimensional location of an object associated with a person at risk of falling down has been implemented in accordance with some embodiments of the disclosed subject matter. As shown, a hard object (e.g., an object which reflects a large amount of incident ultrasound energy) can create a secondary path between an ultrasound transducer and a remote monitor (e.g., remote monitor 102). This may cause the remote monitor to report the reception of additional ultrasound signals. Additionally or alternatively, in some cases, the remote monitor may report only the reception of a reflection, such as when the primary pathway between an ultrasound transducer and the remote monitor is obstructed. This could occur, for example, if a person wearing the remote monitor falls down next to an object that obstructs a straight path between the ultrasound transducer and the remote monitor (e.g., a person may fall next to a bed or table). In such an example, the remote monitor may still receive one or more reflections of the signal, which may be reported causing an error in a distance calculation.

In some embodiments, one or more techniques can be used to attempt to mitigate such potential errors. For example, in some embodiments, while one ultrasound transducer is in a transmit mode, one or more other ultrasound transducers can be in a receive mode and can be used to detect ultrasound signals, the reception of which can be used to determine transmission times corresponding to one or more paths between the transmitting transducer and the receiving transducer. In some embodiments, the mechanisms described herein can use information about multiple path lengths to identify locations of potential sources of reflections. If the transducers are placed such that a straight path exists between each pair of transducers, the local monitor can determine which signal was a primary signal and which signals were due to reflections within the space being monitored. Based on data collected from each pair of transducers, local monitor and/or central monitoring system can attempt to determine likely locations of objects that reflect and/or block ultrasound signals.

Additionally or alternatively, in some embodiments, remote monitor 102 can be implemented with one or more ultrasound transmitters, and remote monitor 102 can be configured to transmit an ultrasounds signal in response to reception of another ultrasound signal. In some embodiments, one or more ultrasound transducers (e.g., ultrasound transducers 514) can be configured to enter receive mode after transmission of an ultrasound signal by one of the transducers, and one or more of the transducers can detect the ultrasound signal emitted by remote monitor 102. In some embodiments, a time at which the primary signal was detected by a particular transmitter can be recorded in connection with a time at which the signal emitted by the remote monitor was recorded.

In some embodiments, the local monitor and/or central monitoring system can use the times at which the primary ultrasound signal and the signal emitted by the remote monitor was detected (or emitted) by a particular transducer to determine a distance from the transducer to the local monitor.

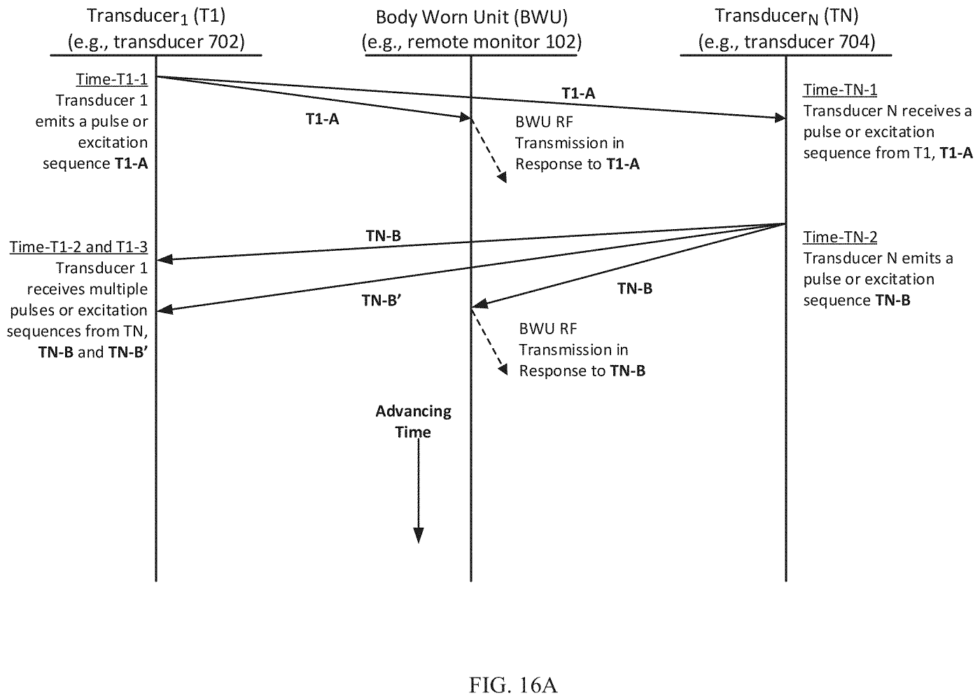

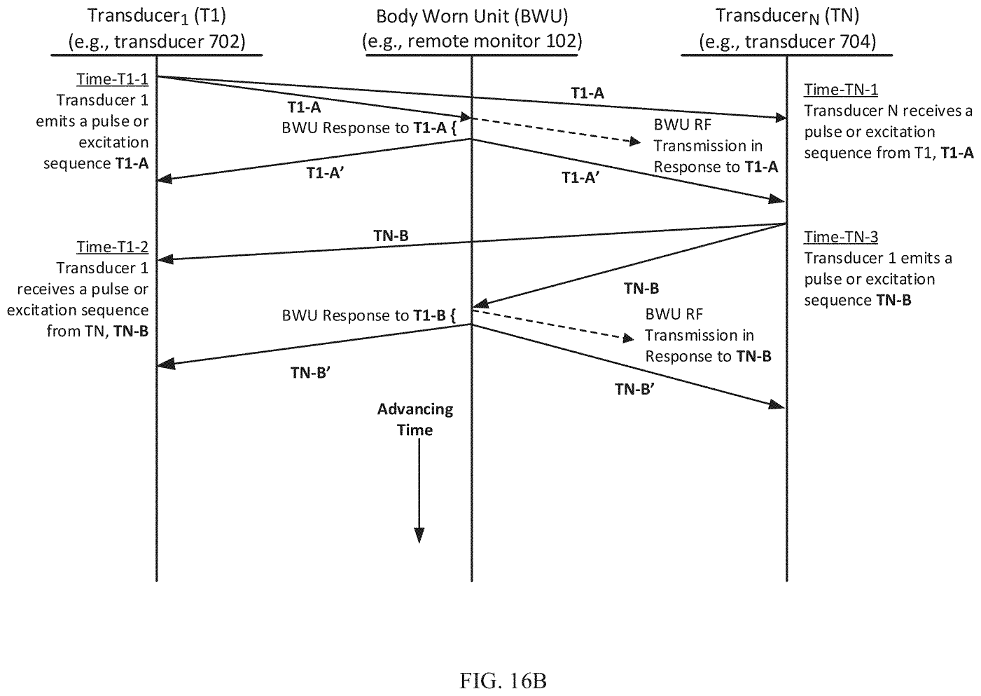

FIG. 16A shows an example of a timing diagram showing signals transmitted and received by various devices in a system for determining three dimensional location of an object associated with a person at risk of falling down has been implemented in accordance with some embodiments of the disclosed subject matter. As shown in FIG. 16A, during and/or after a time period in which a first transducer (e.g., transducer 702/transducer T1) is in a transmit mode, another transducer (e.g., transducer 704/transducer TN) can be in a receive mode, and can detect the ultrasound signal emitted by the first transducer, and in some cases reflected signals that travelled along a different path. Based on the time at which the signal(s) is received, the local monitor and/or central monitoring system can determine the distance represented by the path travelled by the ultrasound signal(s).

FIG. 16B shows another example of a timing diagram showing signals transmitted and received by various devices in a system for determining three dimensional location of an object associated with a person at risk of falling down has been implemented in accordance with some embodiments of the disclosed subject matter. As shown in FIG. 16B, remote monitor 102 can be configured to emit an ultrasound pulse in response to detecting an ultrasound pulse. In some embodiments, the remote monitor can wait a predetermined amount of time prior to emitting the ultrasound signal in order to reduce the chance that the ultrasound transducers will detect a reflected version of the signal emitted by the first transducer in close proximity in time to the signal emitted by the remote monitor. For example, for each transducer, a space being monitored can exhibit an impulse response in connection with the signal emitted by the transducer that includes the primary signal and signals reflected from various surfaces and/or objects in the space. The remote monitor can be configured to wait a predetermined time before transmitting an ultrasound signal in response to a detection of an ultrasound signal to avoid confusion between the tail of the impulse response and the signal emitted by the remote monitor.

In some embodiments, the additional information generated using techniques described in connection with FIGS. 15A to 16B can be used to supplement, replace, and/or correct distance information that is based on an RF signal emitted by the remote monitor.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any other suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that the above described steps of the processes of FIGS. 8 and 9 can be executed or performed in any order or sequence not limited to the order and sequence shown and described in the figures. Also, some of the above steps of the processes of FIGS. 8 and 9 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for determining a three dimensional location of a remote monitor associated with a person at risk of falling down, the system comprising:
a first ultrasonic transducer at a first position in relation to a monitored space;
a second ultrasonic transducer at a second position in relation to the monitored space;
a detector; and
a processor coupled to the first ultrasonic transducer, the second ultrasonic transducer, and the detector, the processor programmed to:
cause the first ultrasonic transducer to emit a first ultrasound signal at a first time;
detect, at a second time that is subsequent to the first time using the detector, a first wireless signal emitted by the remote monitor;
determine a first distance value, representing a distance between the first ultrasonic transducer and the remote monitor at the second time based on a difference between the first time and the second time and a propagation speed of sound in the monitored space;
cause the second ultrasonic transducer to emit a second ultrasound signal at a third time that is subsequent to the first time;
detect, at a fourth time that is subsequent to the third time using the detector, a second wireless signal emitted by the remote monitor; and
determine a second distance value, representing a distance between the second ultrasonic transducer and the remote monitor at the fourth time based on a difference between the third time and the fourth time and the propagation speed of sound in the monitored space.

2. The system of claim 1, wherein the processor is further programmed to determine a location of the remote monitor within the monitored space based on the first distance value, the first position, the second distance value, and the second position.

3. The system of claim 1, further comprising a third ultrasonic transducer at a third position in relation to the monitored space, wherein the processor programmed to:
cause the third ultrasonic transducer to emit a third ultrasound signal at a fifth time;
detect, at a sixth time that is subsequent to the fifth time using the detector, a third wireless signal emitted by the remote monitor; and
determine a third distance value, representing a distance between the third ultrasonic transducer and the remote monitor at the sixth time based on a difference between the fifth time and the sixth time and the propagation speed of sound in the monitored space.

4. The system of claim 1, wherein the detector comprises an antenna, and the first wireless signal is a radio frequency signal.

5. The system of claim 4, wherein a frequency of the first wireless signal is in a range of about 900 MHz to about 930 MHz.

6. The system of claim 4, wherein the first wireless signal is a non-modulated signal, and a frequency of the first wireless is useable to identify the remote monitor from a plurality of remote monitors each configured to emit wireless signals at different frequencies.

7. The system of claim 1, wherein the detector comprises a photodetector, and the first wireless signal is an optical signal.

8. The system of claim 1, wherein the first wireless signal is encoded with at least one of identifying information associated with the remote monitor and identifying information associated with the person.

9. The system of claim 1, wherein the third time is subsequent to the first time by no more than 0.5 seconds.

10. The system of claim 1, wherein the processor is further programmed to transmit the first distance value and the second distance value to a central monitoring system that is programmed to determine a location of the remote monitor within the monitored space based on the first distance value and the second distance value.

11. The system of claim 1, wherein the processor is further programmed to transmit an instruction to the first ultrasound transducer to emit the first ultrasound signal at the first time.

12. The system of claim 11, wherein the processor is further programmed to transmit the instruction to the first ultrasound transducer to emit the first ultrasound signal at the first time over a power line network to which both the processor and the first ultrasound transducer are coupled, over a low voltage line corresponding to the first ultrasound transducer, over a low voltage network to which both the processor and the first ultrasound transducer are coupled, or by causing an activation signal to be emitted by a wireless transmitter coupled to the processor.

13. The system of claim 1, wherein the processor is further programmed to:
determine that at least a first amount of time has elapsed since emission of a most recent ultrasound signal;
in response to determining that at least the first amount of time has elapsed, cause the first ultrasonic transducer to emit the first ultrasound signal at a seventh time;
detect, at an eighth time that is subsequent to the seventh time using the detector, a fourth wireless signal emitted by the remote monitor; and
determine a fourth distance value, representing a distance between the first ultrasonic transducer and the remote monitor at the eighth time based on a difference between the seventh time and the eighth time and the propagation speed of sound in the monitored space.

14. The system of claim 13, wherein the first amount of time is at least 10 seconds.

15. The system of claim 1, wherein the processor is further programmed to:
detect, at a ninth time that is subsequent to the first time using the detector, a fifth wireless signal emitted by a second remote monitor;
determine a fifth distance value, representing a distance between the first ultrasonic transducer and the second remote at the ninth time monitor based on a difference between the first time and the ninth time and the propagation speed of sound in the monitored space;
detect, at a tenth time that is subsequent to the third time using the detector, a sixth wireless signal emitted by the second remote monitor; and
determine a sixth distance value, representing a distance between the second ultrasonic transducer and the second remote monitor at the tenth time based on a difference between the third time and the tenth time and the propagation speed of sound in the monitored space.

16. A wearable apparatus comprising:
an ultrasound detector;
an antenna; and
a processor, the processor programmed to:
detect a first ultrasound signal at a first time using the ultrasound detector;
in response to detecting the first ultrasound signal, cause a first wireless signal to be emitted by the antenna;
detect a second ultrasound signal at a second time;
in response to detecting the second ultrasound signal, cause a second wireless signal to be emitted by the antenna;
determine that a first amount of time has passed since the second ultrasound signal was detected; and
in response to determining that the first amount of time has passed since the second ultrasound signal was detected, cause the wearable apparatus to enter a low power state.

17. The wearable apparatus of claim 16, wherein the processor is further programmed to cause the wearable apparatus to enter a high power state in response to detection of the first ultrasound signal during a period of time during which the wearable apparatus is in the low power state.

18. The wearable apparatus of claim 16, further comprising a second antenna, wherein the processor is further programmed to:
detect a third ultrasound signal at a third time using the ultrasound detector, wherein the third time falls between the first time and the second time; and
in response to detecting the third ultrasound signal, cause a third wireless signal to be emitted by the second antenna.

19. The wearable apparatus of claim 16, further comprising a battery.

20. The wearable apparatus of claim 16, further comprising a temperature sensor, wherein the processor is further programmed to encode a value indicative of an output of the temperature sensor in the first wireless signal.

21. The wearable apparatus of claim 16, wherein the processor is further programmed to:
determine that at least a second amount of time has passed without detection of an ultrasound signal; and
in response to determining that at least a second amount of time has passed without detection of an ultrasound signal, cause a fourth wireless signal to be emitted by the antenna.

22. The wearable apparatus of claim 21, wherein the processor is further programmed to encode the fourth wireless signal with information indicating that the fourth wireless signal does not correspond to a detection of an ultrasound signal.

23. The wearable apparatus of claim 16, wherein the processor is further programmed to encode the first wireless signal with identifying information associated with the wearable apparatus.

24. The wearable apparatus of claim 16, wherein the processor is further programmed to cause the first wireless signal to be emitted using a particular frequency that is associated with the wearable apparatus in lieu of encoding the first wireless signal with identifying information associated with the wearable apparatus.

25. The wearable apparatus of claim 16, wherein the processor is further programmed to:
determine a duration of the first ultrasound signal; and
cause a duration of the first wireless signal to be equal to the duration of the first ultrasound signal.

26. The wearable apparatus of claim 16, further comprising a pressure sensor, wherein the processor is further programmed to encode a value indicative of an output of the pressure sensor in the first wireless signal.

27. The wearable apparatus of claim 16, further comprising a proximity detector coupled to a proximity coil, wherein the processor is further programmed to encode a value indicative of a state of the proximity coil in the first wireless signal.

28. The wearable apparatus of claim 16, further comprising an ultrasonic transducer, wherein the processor is further programmed to:
in response to detecting the first ultrasound signal, cause a third ultrasound signal to be emitted by the ultrasonic transducer after a predetermined period of time.
